(19) United States
(12) Patent Application Publication
(10) Pub. No.: US 2006/0254626 A1
(43) Pub. Date: Nov. 16, 2006

(54) Fluid treatment system for use with a washing appliance

(76) Inventors: David M. Botts, Minnetrista, MN (US); Karl J. Fritze, Hastings, MN (US); Donald J. Hammer, Lake City, MN (US); William J. Meuleners, Webster, MN (US); Christopher A. Molitor, Bloomington, MN (US)

Correspondence Address: CUNO Incorporated, 400 Research Parkway, Meriden, CT, 06450-1018, US

(21) Appl. No.: 11/317,507

(22) Filed: Dec. 23, 2005

Related U.S. Application Data
(60) Provisional application No. 60/640,291, filed on Dec. 30, 2004.

(51) Int. Cl. D06F 35/00; B08B 3/00

(52) U.S. Cl. 134/110; 134/56 D; 134/58 D; 134/109; 68/17 R; 68/18 F

(57) ABSTRACT

The present invention relates to washing appliances making use of fluids and fluid delivery systems. More particularly, the present invention relates to washing appliances having a fluid treatment system for treating a fluid that can be used or delivered by the appliance, with suitable treatments including, for example, filtration and/or addition of additives, such as rinse aids, detergents and/or the like.

### REFERENCE TO RELATED APPLICATION

The present application claims the benefit of U.S. Provisional Application No. 60/640,291, filed Dec. 30, 2004, and entitled, “FLUID TREATMENT SYSTEM FOR USE WITH A WASHING APPLIANCE,” which is herein incorporated by reference to the extent not inconsistent with the present disclosure.

### BACKGROUND

The present disclosure relates to washing appliances making use of fluids and fluid delivery systems. More particularly, the present disclosure relates to washing appliances having a fluid treatment system for treating a fluid that can be used or delivered by the appliance, with suitable treatments including, for example, filtration and/or addition of additives, such as rinse aids, detergents and/or the like.

In both residential and commercial environments, it is common to make use of washing appliances such as, for example, dishwashers or clothes washers to clean items that have become dirty during use. For instance, dishwashers are employed residentially and commercially to remove amounts of food, drink and other materials from dishes, glassware, pots, utensils and flatware for reuse. In addition, clothes washers are also used both residentially and commercially to clean dirty or soiled items such as, for example, clothing, towels, sheets and the like.

Generally, washing appliances make use of fluid sources such as a residential or commercial water supply to provide the base for a cleaning medium inside the washing appliance. A cleaning chemical such as, for example, a detergent, a bleach, and/or a soap is typically added to the cleaning medium to further promote the ability of the washing appliance to clean the dirty items. The cleaning chemical can have a solid, powdered, gel or liquid form and can be added to the cleaning medium at the beginning of a cleaning cycle and/or at other stages of the cleaning process.

As part of the cleaning process, washing appliances typically can include rinsing functions with a final rinse for removing remaining cleaning chemical or other deposits from a clean item. An initial rinse function can be used to loosen deposits and remove at least about a portion of deposits prior to performing a rinse wash cycle. In some instances, the rinsing function can be used prior to a drying function. In this manner, the rinsing function is used to impart a satisfying visual appearance to the cleaned item, which further enhances a potential users satisfaction during future use of the item.

### SUMMARY

It can be desirable to have a filtration system integral to a washing appliance. In some instances, the filtration system can be configured so as to supply a filtered fluid, such as water, for use during the cleaning process and/or rinsing process. For example, a suitable filtration system can be used to remove dissolved minerals, organic matter or particulate matter that has the potential to interfere with the operation and/or service life of the washing appliance or components thereof. In addition, the use of a water filtration system can be used to improve the overall performance of the appliance, for example, by eliminating spotting in a dishwasher or providing cleaner clothes in a washing machine. In other instances, a washing appliance can include a filtration system for filtering and removing particulate matter such as, for example, food particles in a dishwasher, and other contaminants that become entrained in the cleaning medium such that the filtered matter is not returned or redeposited on the items being cleaned. Furthermore, it can be desirable to combine the filtration system with one or more additive dispensers for an integrated fluid treatment system.

A fluid treatment system as presently described and contemplated can provide a flow structure for promoting a cleaning cycle within a washing appliance. In some presently preferred embodiments, the fluid treatment system can selectively provide filtered water as requested by a controller responsible for overall operation of the washing appliance. The presently contemplated fluid treatment system can selectively provide differing qualities of a filtered fluid, for example, based upon particular stages of the cleaning cycle as directed by the controller. In additional or alternative presently preferred embodiments, the fluid treatment system can be adapted so as to selectively introduce additives to assist with or enhance the cleaning process as directed by the controller.

In some presently preferred representative embodiments, improved fluid treatment systems for use with a washing appliance can incorporate a plurality of filtration stages. These filtration stages can be correlated with specific cycles within the washing process. In some embodiments, a filter can be used to filter all fluid, such as water, entering the wash appliance. This initial filter can remove larger particulates and/or other undesirable potential components of the incoming fluid to improve the wash process and/or to lengthen the lifetime of the components of the appliance. For example, removal of particulates can lengthen the lifetime of valves within the appliance and reduce the need for servicing the appliance. In presently preferred representative embodiments, a prefilter can be configured for easy replacement when the filter is determined to be spent. An interchangeable prefilter is in contrast with crude screen filters, which require disassembly to replace, that become clogged only if an unusual event takes place with respect to the presence of large particulates in the inflow. In some representative embodiments described below, a final rinse filter can be used to provide particularly purified fluid for the final cycle of the washing appliance. The ability to filter all or a selected portion of inflow fluid, e.g., water from a fresh water supply, provides the ability to provide cleaner water to the washing and/or rinsing cycle than is provided a water supply. This ability acknowledges that many conventional water supplies do not provide a desired quality of water for many cleaning applications either due to deterioration of the water supply or a heightened standard for many consumers.

In some additional or alternative presently preferred representative embodiments, one or more filtration stages can be combined with one or more additive dispensers, although in some embodiments desirable dispenser designs can be used without filtration. Suitable additives can be, for example, a rinse aid, a detergent, a disinfectant or the like. Coordinating the use of various filtration stages with dispensers can provide for improved operation of the washing appliance. As appropriate for some representative embodiments, by combining a dispenser with a filter within a unitary fluid treatment system, simpler assembly of the fluid treatment system within the appliance is accomplished with fewer fluid connections that need to be made at final assembly. Furthermore, by coordinating the flow paths and/or system control of the additive dispensers with a filtration component, greater flexibility in fluid treatment options can be achieved.

In one aspect, the fluid treatment system of the present disclosure can comprise a manifold assembly adapted to selectively receive at least one replaceable treatment assembly holding a composition for imparting a desirable characteristic to a cleaning medium. The manifold assembly can comprise integral flow channels and associated valving for selectively directing a cleaning fluid through the at least one replaceable treatment assembly and to the washing appliance as directed by an appliance controller. The manifold assembly can be integrally mounted within the structure of the washing appliance for treatment of all or a selected portion of incoming cleaning fluid. The manifold assembly can be electrically, operably connected to a controller within the washing appliance to selectively direct and treat water as part of a wash cycle.

In another aspect, the fluid treatment system of the present disclosure can comprise a replaceable treatment assembly. In one representative configuration, the replaceable treatment assembly can comprise a plurality of filter media whereby each medium is selected to provide a desired level or type of filtration that is beneficial to a selected stage of a washing process. Suitable filtering media can be selected from filtering media such as, for example, depth filtration mediums, surface filtration mediums, adsorptive media, crossflow filtration media, ion exchange media, activated carbon media and the like. The multiple filtration media can be separately packaged within cartridges, and these separate media can be integrated as desired into a flow path to selectively supply fluid with different levels of treatment at selected times during the wash cycle. Specifically, in a representative configuration, the replaceable treatment assembly can comprise a plurality of separably replaceable treatment cartridges. In yet another representative configuration, the replaceable treatment system can further comprise an additive assemble for selectively dispensing an additive into the washing appliance as directed by a controller. Suitable additives can include additives such as, for example, detergents, soaps, fragrances, rinse aids and the like.

In additional aspects, a washing appliance can comprise an integral fluid treatment system for supplying a cleaning fluid that is selectively treated as dictated by an appliance controller. In some instances, the cleaning fluid can be selectively filtered with a filter medium such as, for example, depth filtration mediums, surface filtration mediums, crossflow filtration mediums, ion exchange mediums, activated carbon mediums and the like. In some instances, the cleaning fluid can be treated through the addition of an additive such as, for example, detergents, soaps, fragrances, rinse aids and the like.

In a further aspect, the present disclosure is directed to a method of providing a treated cleaning fluid to a washing appliance. In some instances, a cleaning fluid can be selectively filtered at the direction of an appliance controller. In some instances, additives for enhancing a cleaning process can be selectively dispensed at the direction of an appliance controller.

In other aspects, the present disclosure is directed to fluid treatment systems that can comprise compact designs allowing for placement with an appliance body or door without significantly increasing the overall size of the appliance or sacrificing usable washing space.

In another aspect, the present disclosure is directed to fluid treatment systems that can utilize flow manifolds allowing for quick and easy replacement of replaceable filter assemblies. These replaceable filter assemblies can comprise a variety of filter media for removing contaminants such as, for example, particulate matter or dissolved solids, such as hardness or iron, so as to protect downstream components such as valves, injectors and venturis from damage or effect operation, such as clogging or jamming of downstream flow components that are in fluid contact with the fluid stream.

In another aspect, the present disclosure is directed to fluid treatment systems comprising an upstream flow component such as, for example, a valve or orifice, so as avoid exposure of portions of the fluid treatment system to high pressure conditions, i.e., above 120 psig. Through the use of the upstream flow component, fluid treatment systems can be effectively broken into three distinct pressure regions including a house pressure region, a variable pressure region and an atmospheric pressure region. The house pressure region generally comprises a portion of the fluid treatment system upstream of the upstream flow component. The house pressure region is generally manufactured to withstand exposure to high pressure conditions such as, for example, pressures between about 60 to about 120 psig. The variable pressure region comprises a portion of the fluid treatment system directly downstream of the upstream flow component. The variable pressure region is manufactured to withstand normal operation at a pressure range from roughly atmospheric pressure to about 120 psig. The atmospheric pressure region comprises a portion of the fluid treatment system that directly fluidly interacts with an interior portion of a dishwasher. The atmospheric pressure region is manufacture to operate at essentially atmospheric pressure. By preventing the exposure of portions of the fluid treatment system to high pressure conditions, portions of the fluid treatment system such as, for example, the variable pressure and atmospheric pressure regions can be fabricated with low pressure designs. Through the use of low pressure designs, fabrication costs for the overall fluid treatment system can be reduced such as, for example, by reducing wall thicknesses which correspondingly leads to reductions in raw material consumption.

In another aspect, the present disclosure is directed to fluid treatment systems comprising a variety of treatment and washing mediums, such as, for example, detergents, soaps, rinse aids, and filter elements. Each of the various treatment and washing mediums can be fabricated with individually distinct connecting features relative to interconnection with a manifold assembly such that the risk of replacing a spent medium with a wrong or incompatible medium is eliminated. When a spent medium is replaced, the medium can be filled into a removable, replaceable receptacle that comprises the distinct connecting feature, or alternatively, the various mediums can be provided in individual use sizes, such as bags or housings, that include the distinct connecting feature and eliminate the need to transfer the medium from a bulk container into a removable, replaceable container.

Moreover, the present disclosure is directed to replaceable filter cartridges and/or fluid treatment reservoirs that can be coupled to a fluid treatment system of a washing appliance in a configuration in which they can be replaced without disassembly of the appliance. In some presently preferred representative embodiments, the filter cartridges and/or the fluid treatment reservoirs can be accessibly from a kick panel of the applicant and/or from a panel within the door of the appliance. Suitable connectors are can be used for the quick replacement of either a filter element and/or a fluid treatment reservoir that is easy and generally valved such that cleaning fluid does not flow when the filter or reservoir is absent. Thus, significant new functionality is introduced that can be conveniently maintained by the end user without great effort.

In a further aspect, the present disclosure is directed to fluid treatment systems comprising various combinations of controls, sensors and/or display mechanisms so as to automate various functions of the fluid treatment system. Representative functions suitable for automation can include the dispensing of a wash medium, indicating the absence and/or remaining amount of a wash medium, indicating the status and/or remaining capacity of a filtering medium and to provide an indication of operational problems with the fluid treatment system.

In another aspect, the present disclosure is related to additive assemblies for administering a wash medium into a fluid stream. In some representative fluid treatment systems, a wash medium can be dispensed and administered into a fluid stream through an injector assembly utilizing the driving force of a fluid supply to direct the wash medium into the fluid stream or washing appliance. In some representative fluid treatment systems, additive assemblies can comprise an adjustable additive assembly for varying the amount of wash medium that is dispensed or administered into a flow stream based on characteristics of a fluid source, such as, fore example, levels of hardness, iron and the like.

Additionally, the present disclosure is related to dispensers for a washing appliance that are based on a venturi effect, i.e. aspiration. The venturi provide a small orifice nozzle adjacent to the dispenser inlet operatively coupled to a reservoir with a check valve or the like. Flow through the nozzle to an adjacent flow conduit provides suction that opens the check valve and provides flow from the dispenser into the flow through the nozzle. In an adjustable version, an adjustment of the venturi nozzle to change its positioning relative to the adjacent flow conduit to increase or decrease the suction and corresponding amount of flow from the dispenser. The venturi-based dispensers, especially the adjustable venturi dispenser, can find valuable applications outside of use within a washing appliance.

### BRIEF DESCRIPTION OF THE DRAWINGS

FIG. 1 is a flow schematic for a representative embodiment of a fluid treatment system for use with a washing appliance incorporating a filtered rinse circuit, a wash soap circuit and a low-pressure final rinse circuit including a rinse additive.

FIG. 2 is a flow schematic for a representative embodiment of a fluid treatment system for use with a washing appliance incorporating a filtered rinse circuit, a wash soap circuit and a high-pressure final rinse circuit including a rinse additive.

FIG. 3 is a flow schematic for a representative embodiment of a fluid treatment system for use with a washing appliance incorporating a filtered rinse circuit and a low-pressure final rinse circuit including a rinse additive.

FIG. 4 is a flow schematic for a representative embodiment of a fluid treatment system for use with a washing appliance incorporating a filtered rinse circuit, a wash soap circuit and a low-pressure final rinse circuit.

FIG. 5 is a perspective view of a washing appliance including an embodiment of a fluid treatment system with two inserts of the figure illustrating alternative exploded perspective views of the fluid treatment system removed from the appliance.

FIG. 6 is a perspective view of a washing appliance including an embodiment of a fluid treatment system with a first insert illustrating the fluid treatment system removed from the appliance and a second insert illustrating an exploded view of the fluid treatment system.

FIG. 7 is a perspective view of a washing appliance including an embodiment of a fluid treatment system with three inserts illustrating different exploded perspective views of the fluid treatment system removed from the appliance.

FIG. 8 is a perspective view of an embodiment of a fluid treatment system removed from an appliance.

FIG. 9 is a front view of a dishwasher including a door mounted embodiment of a fluid treatment system.

FIG. 10 is a side view of the dishwasher of FIG. 9.

FIG. 11 is a perspective view of the dishwasher of FIG. 9 with the door in an open position exposing an interior portion of the dishwasher.

FIG. 12 is a front view of the dishwasher of FIG. 9 depicting the positioning of the fluid treatment system within the door and dishwasher body with a hidden valve structure shown for clarity and hidden structure connected to the valve structure shown in phantom lines.

FIG. 13 is a side view of the dishwasher of FIG. 9 depicting the positioning of the fluid treatment system within the door and dishwasher body with a hidden valve structure shown for clarity and hidden structure connected to the valve structure shown in phantom lines.

FIG. 14 is a perspective rear view of the dishwasher door depicting the positioning of the fluid treatment system within the dishwasher door with a hidden valve structure shown for clarity and hidden structure connected to the valve structure shown in phantom lines.

FIG. 15 is an expanded, fragmentary hidden perspective rear view of the dishwasher door illustrating a dispensing portion of the fluid treatment system with hidden structure shown in phantom lines.

FIG. 16 is a front view of an embodiment of a fluid treatment system for use with 5 dishwasher of FIG. 9 with other portions of the dishwasher removed for clarity.

FIG. 17 is a side view of the fluid treatment system of FIG. 16.

FIG. 18 is a front view of an embodiment of a distribution manifold used in constructing the fluid treatment system of FIG. 16.

FIG. 19 is a side view of the distribution manifold of FIG. 18.

FIG. 20 is an end view of the distribution manifold of FIG. 18 relative to the left end shown in FIG. 18.

FIG. 21 is a perspective view of a representative embodiment of an adjustable venturi injector assembly.

FIG. 22 is a side view of the adjustable venturi injector assembly of FIG. 21.

FIG. 23 is a top view of the adjustable venturi injector assembly of FIG. 21.

FIG. 24 is an end view of the adjustable venturi injector assembly of FIG. 21.

FIG. 25 is a sectional view of the adjustable venturi injector assembly of FIG. 21 taken at Line 25-25 of FIG. 24.

FIG. 26 is an expanded sectional view of a venturi flow channel of the adjustable venturi injector assembly of FIG. 21 taken within the circle indicated in FIG. 25.

FIG. 27 is a perspective view of a representative embodiment of an additive assembly for use with the adjustable venturi injector assembly of FIG. 21.

FIG. 28 is a side view of the additive assembly of FIG. 27.

FIG. 29 is a sectional view of the additive assembly of FIG. 27 taken at Line 29-29 of FIG. 28.

FIG. 30 is an expanded sectional view of a dispensing end of the additive assembly of FIG. 27 taken at the circle noted in FIG. 29.

FIG. 31 is a side view of a representative embodiment of a dispenser assembly for use with the additive assembly of FIG. 27.

FIG. 32 is a perspective bottom view of the dispenser assembly of FIG. 31.

FIG. 33 is a perspective top view of the dispenser assembly of FIG. 31.

FIG. 34 is a bottom end view of the dispenser assembly of FIG. 31.

FIG. 35 is a fragmentary sectional view depicting the dispensing end of the additive assembly of FIG. 27 in proximity to an additive inlet portion of the variable venturi injector assembly of FIG. 21.

FIG. 36 is a fragmentary sectional view depicting operable, fluid connection of the additive assembly of FIG. 27 with the variable venturi injector assembly of FIG. 21.

FIG. 37 is a perspective view of a representative embodiment of a fixed venturi injector assembly.

FIG. 38 is a side view of the fixed venturi injector assembly of FIG. 37.

FIG. 39 is a top view of the fixed venturi injector assembly of FIG. 37.

FIG. 40 is an end view of the fixed venturi injector assembly of FIG. 37.

FIG. 41 is a sectional view of the fixed venturi injector assembly of FIG. 37 taken at Line 41-41 of FIG. 40.

FIG. 42 is a perspective view of a representative embodiment of a hydraulic injector assembly.

FIG. 43 is an exploded, perspective view of the hydraulic injector assembly of FIG. 42.

FIG. 44 is an alternative exploded, perspective view of the hydraulic injector assembly of FIG. 42.

FIG. 45 is a perspective, sectional view of the hydraulic injector assembly of FIG. 42 taken through the center of the flow channels.

FIG. 46 is a top sectional view of the hydraulic injector assembly of FIG. 42.

FIG. 47 is a bottom sectional view of the hydraulic injector assembly of FIG. 42 in which the section is taken in the opposite direction of the section in FIG. 46.

FIG. 48 is a perspective, double sectional view of the hydraulic injector assembly of FIG. 42 in which one section is taken as in FIG. 47 and the second section is taken along line 48-48 of FIG. 47.

FIG. 49 is a perspective, cut-away view of the hydraulic injector assembly of FIG. 42.

FIG. 50 is a perspective, partial cut-way view of a portion of the hydraulic injector assembly of FIG. 42 including arrows representative of fluid flow and piston movement during use of the hydraulic injector assembly.

FIG. 51 is a schematic flow diagram of an embodiment of a fluid treatment system for use with a washing appliance.

FIG. 52 is a schematic flow diagram of an alternative embodiment of a fluid treatment system for use with a washing appliance.

FIG. 53 is a schematic flow diagram of a second alternative embodiment of a fluid treatment system for use with a washing appliance.

FIG. 54 is a schematic flow diagram of a third alternative embodiment of a fluid treatment system for use with a washing appliance.

FIG. 55 is a schematic flow diagram of a fourth alternative embodiment of a fluid treatment system for use with a washing appliance.

FIG. 56 is a schematic flow diagram of a fifth alternative embodiment of a fluid treatment system for use with a washing appliance.

FIG. 57 is a schematic flow diagram of a sixth alternative embodiment of a fluid treatment system for use with a washing appliance.

FIG. 58 is a schematic flow diagram of a seventh alternative embodiment of a fluid treatment system for use with a washing appliance.

FIG. 59 is a schematic flow diagram of an eighth alternative embodiment of a fluid treatment system for use with a washing appliance.

FIG. 60 is a schematic flow diagram of a ninth alternative embodiment of a fluid treatment system for use with a washing appliance.

FIG. 61 is a schematic flow diagram of a tenth alternative embodiment of a fluid treatment system for use with a washing appliance.

FIG. 62 is a schematic flow diagram of an eleventh alternative embodiment of a fluid treatment system for use with a washing appliance.

FIG. 63 is a schematic flow diagram of a twelfth alternative embodiment of a fluid treatment system for use with a washing appliance.

### DETAILED DESCRIPTION

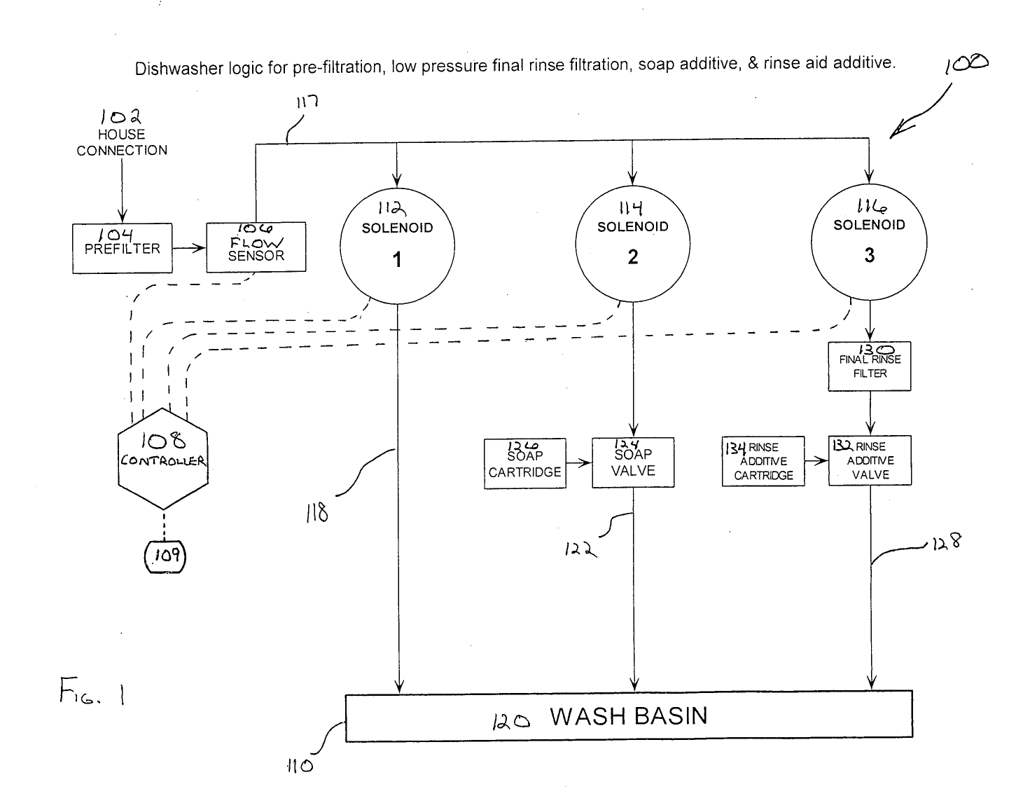

A flow schematic of a representative fluid treatment system 100 for use with a washing appliance is illustrated in FIG. 1. Fluid treatment system 100 is generally used to treat a cleaning fluid to enhance a cleaning and/or rinsing process within the washing appliance. As discussed throughout the following disclosure, the cleaning fluid most often comprises water though it is not intended that the use of fluid treatment system 100 be limited to the treatment of water.

As illustrated in FIG. 1, fluid treatment system 100 is operatively connected to a fluid source at a source inlet such as, for example, house connection 102. The fluid source can comprise, for example, a residential or commercial water supply when the cleaning fluid is water. Where the fluid source comprises a residential or commercial water supply, the water may comprise municipally treated water or the like as well as, additionally or alternatively, well water or the like. House connection 102 can comprise a suitable connector such as, for example, a tubing or piping connector, to operatively connect and seal the fluid treatment system 100 with respect to the fluid source.

Fluid treatment system 100 can further comprise a prefilter 104 and a flow sensor 106. Prefilter 104 can comprise a removably replaceable filter such as, for example, a replaceable cartridge filter as described in U.S. Pat. Nos. 6,649,056 and 6,953,526; and U.S. Publication Nos. 2003-0010698 A1, 2003-0019819 A1, and 2003-0217959 A1, all of which are herein incorporated by reference to the extent not inconsistent with the present disclosure. Prefilter 104 generally comprises a filter media selected so as to filter the wash fluid. When, for example, the wash fluid comprises water, suitable filter medias may comprise depth style barrier filtration media, surface style filtration media, activated carbon filtration media, ion exchange media, crossflow filtration media, ceramic filtration media and any other suitable filtration medias. Flow sensor 106 can comprise any suitable flow sensor such as, for example, Hall Effect sensors, paddlewheel sensors, turbine sensors, ultrasonic sensors and the like, which can provide an output signal, either analog or digital, to a controller 108. Controller 108 can be integral to the fluid treatment system 100 and/or may comprise an element of a washing appliance 110. Controller 108 can comprise any suitable controller such as, for example, a microprocessor based controller, a Programmable Logic Controller (PLC), a relay-logic based controller, a terminal strip or other suitable controllers. Controller 108 can be operably interconnected to a display 109 for visually and/or audibly communicating information collected by controller 108 to a user.

Display 109 can comprise a simple display including lights for detailing system information or alternatively, display 109 can comprise viewing screens such as, for example, a LCD (liquid crystal display) or similar display for communicating detailed system information. Display 109 can communicate to a user information such as, for example, operation information such as cycle and system alarms, amounts remaining of wash mediums such as, for example, rinse aid, detergent and the like, and capacity information relating to the use of prefilter 104. Display 109 can be mounted within a door, control panel or remotely for providing information to the user.

Fluid treatment system 100 can further comprise a rinse valve 112, a wash valve 114 and a final rinse valve 116, each being in fluid communication with a prefiltered flow line 117. As shown in FIG. 1, rinse valve 112, wash valve 114 and final rinse valve 116 can comprise actuatable valves that are operably electrically connected to the controller 108. In one presently preferred representative embodiment, rinse valve 112, wash valve 114 and final rinse valve 116 can comprise similar valve styles such as, for example, solenoid valves as shown in FIG. 1. Alternatively, each of rinse valve 112, wash valve 114 and final rinse valve 116 can comprise other independently actuatable valve configurations such as, for example, alternative electrically, pneumatically or hydraulically actuated valve configurations.

As illustrated in FIG. 1, rinse valve 112 can selectively control flow through a rinse flow line 118 for directing wash fluid into a washbasin 120 of washing appliance 110. Wash valve 114 similarly controls flow through a soap flow line 122. Soap flow line 122 can operably comprise a soap valve 124 and a soap cartridge 126. Soap valve 124 can comprise a suitable valve design for introducing a washing soap such as for example, a liquid or gel type washing soap, into the wash fluid. Soap valve 124 can comprise a venturi style design in which the washing soap is drawn into the wash fluid through suction generated from the flow in rinse flow line 118 due to a venturi effect. Alternatively, soap flow line 122 can further include an injector or a pump such as, for example, a peristaltic, diaphragm or other suitable pump design suitable for introducing and/or mixing the washing soap or from soap cartridge 126 into the wash fluid.

Final rinse valve 116 similarly controls flow through a final rinse flow line 128. Final rinse flow line 128 can operably comprise a final rinse filter 130, a rinse additive valve 132 and/or a rinse additive cartridge 134. Final rinse filter 130 can comprise a replaceable filter having a similar configuration as prefilter 104, or it can have a different configuration. In some presently contemplated embodiments, prefilter 104 and final rinse filter 130 may comprise individually replaceable filter assemblies, while in other presently contemplated embodiments, prefilter 104 and final rinse filter 130 may be operatively joined in a single unitary filter assembly that is replaced as a unit. Rinse additive valve 132 can comprise a suitable valve design for introducing and/or mixing a rinse additive or disinfectant such as for example, a liquid or gel type rinse additive, into the final rinse fluid. Rinse additive valve 132 can comprise a venturi style design in which the rinse additive is drawn into the wash fluid through suction generated from the flow in final rinse flow line 128 due to a venturi effect. Alternatively, final rinse flow line 128 can further comprise an injector or a pump such as, for example, a peristaltic, diaphragm or other suitable pump design suitable for introducing the rinse additive into the final rinse fluid.

In some presently contemplated embodiments, soap flow line 122 and final rinse flow line 128 may share a common pump, injector or venturi-style valve for selectively introducing a wash soap or a rinse additive as directed by the controller 108. In such an arrangement, soap valve 124 and rinse additive valve 132 can be selectively controlled by controller 108 to open and close based upon a preset wash cycle. Alternatively, soap valve 124 and rinse additive valve 132 can be incorporated into a single, shared valve having at least two inlets and at least one outlet wherein this single, shared valve simulates the function and operability of soap valve 124 and rinse additive valve 132.

Though rinse flow line 118, soap flow line 122 and final rinse flow line 128 are depicted in FIGS. 1, 2, 3 and 4 as individually connecting to wash basin 120, it is to be understood that rinse flow line 118, soap flow line 122 and final rinse flow line 128 can be operably interconnected so as feed the wash basin 120 with a single fluid line or with alternative configurations of multiple flow lines such as two flow lines.

In general, the fluid treatment system can be placed at any convenient location within the washing appliance or adjacent the washing appliance. The components of the water treatment system may or may not be part of an integral unit, and different components can be separated in location with appropriate operable fluid and electrical connections interfacing the respective components. In presently preferred embodiments, the components are arranged in a limited number of integral units that can be assembled into a suitable location within the appliance with the valves and internal fluid connections being secured within the integral units such that only fluid connections and electrical connections to the integral unit are performed for assembly of the fluid treatment system within the washing appliance. The selected location should provide reasonable access to the user for the replacement of components, such as filter cartridges and additive containers, that become spent during operation and that require occasional replacement.

For example, for the assembly of a fluid treatment system for use with a dishwasher, one or more filter cartridges along with the corresponding manifold and corresponding valves generally can be placed within the kick panel area. This placement generally does not reduce the available space for the cleaning basin, and it provides for the replacement of the filter cartridge from the accessible front of the appliance. An additive dispenser for a rinse aid or the like generally can be combined with a two-stage filter system at one side of the kick panel. If a detergent dispenser is included within the system, this can use a larger volume and can be placed on the opposite side of the kick panel. The central portion of the kick panel area may be occupied by motors, pumps and/or the like for the operation of the washing appliance such that placement of the fluid treatment components on the ends of the kick panel does not interfere with the standard placement of the washing appliance components.

In operation, washing appliance 110 typically washes items through a sequenced series of operations so as to create a cleaning cycle. For example, washing appliance 110 can comprise a cleaning cycle in which items such as, for example, dishes, glassware, pots, utensils or flatware in the case of dishwashers, are washed so as to remove any deposits and/or to sanitize the items. Controller 108 can direct the cleaning cycle and is used to selectively direct fluid corresponding to the desired wash operation through the fluid treatment system 100. For example, a simple wash cycle can comprise a pre-rinse stage, a wash stage, a postrinse stage and a final rinse stage.

During the pre-rinse stage or a portion thereof, controller 108 can transmit a signal to rinse valve 112 such that rinse valve 112 is operably positioned in a valve open disposition while wash valve 114 and final rinse valve 116 remain in a valve closed disposition. In this pre-rinse stage, wash fluid enters the fluid treatment system 100 through the source inlet 102 whereby selected contaminants such as, for example, particulate matter can be removed from the wash fluid by prefilter 104. The flow rate of the wash fluid can be measured by flow sensor 106, which can transmit the flow rate of the wash fluid to the controller 108. The wash fluid flows through the prefiltered flow line 117, through the open rinse valve 114 such that the wash fluid is directed into the washbasin 120.

During the wash stage or a portion thereof, controller 108 can transmit a signal to wash valve 114 such that wash valve 114 is operably positioned in a valve open disposition while rinse valve 112 and final rinse valve 116 remain in a valve closed disposition. In this wash stage, wash fluid enters the fluid treatment system 100 through the source inlet 102 whereby selected contaminants are again removed from the wash fluid by prefilter 104. The flow rate of the wash fluid can be measured by flow sensor 106, which can transmit the flow rate of the wash fluid to the controller 108. The wash fluid flows through the prefiltered flow line 117, through the open wash valve 114 such that the wash fluid is directed through the soap valve 124. Soap valve 124 can introduce wash soap from soap cartridge 126 into the wash flow line 122. The combination of wash fluid and wash soap is then directed into washbasin 120.

The post rinse stage can be similar to the pre-rinse stage in which the wash fluid is again directed through an open rinse valve 112 while soap valve 114 and final rinse valve 116 are in valve closed configurations. The wash fluid flows through the rinse flow line 118 into the washbasin 120.

During the final rinse stage or a portion thereof, controller 108 transmits a signal to final rinse valve 116 such that final rinse valve 116 is operably positioned in a valve open disposition while rinse valve 112 and soap valve 114 remain in a valve closed disposition. In this final rinse stage, wash fluid enters the fluid treatment system 100 through the source inlet 102 whereby selected contaminants are again removed from the wash fluid by prefilter 104. The flow rate of the wash fluid can be measured by flow sensor 106, which can transmit the flow rate of the wash fluid to the controller 108. The wash fluid flows through the prefiltered flow line 117 and past the open final rinse valve 116 such that the wash fluid is directed into the final rinse filter 130. Final rinse filter 130 provides additional filtering of the wash fluid beyond that provided by prefilter 104. For example, final rinse filter 130 can comprise an activated carbon media removing organic material and chlorine from the wash fluid while the prefilter 104 comprises depth filtration media for removing particulates. As the wash fluid flows from the final rinse filter 130, the wash fluid can be directed into the rinse additive valve 132 such that rinse additive from rinse additive cartridge 134 can be introduced into the wash fluid within final rinse flow line 128. The combination of wash fluid and optional rinse additive is then directed into washbasin 120. In other presently preferred representative embodiments, multiple valves can be opened during all or the same or different selected portions of any particular cycle of the cleaning function.

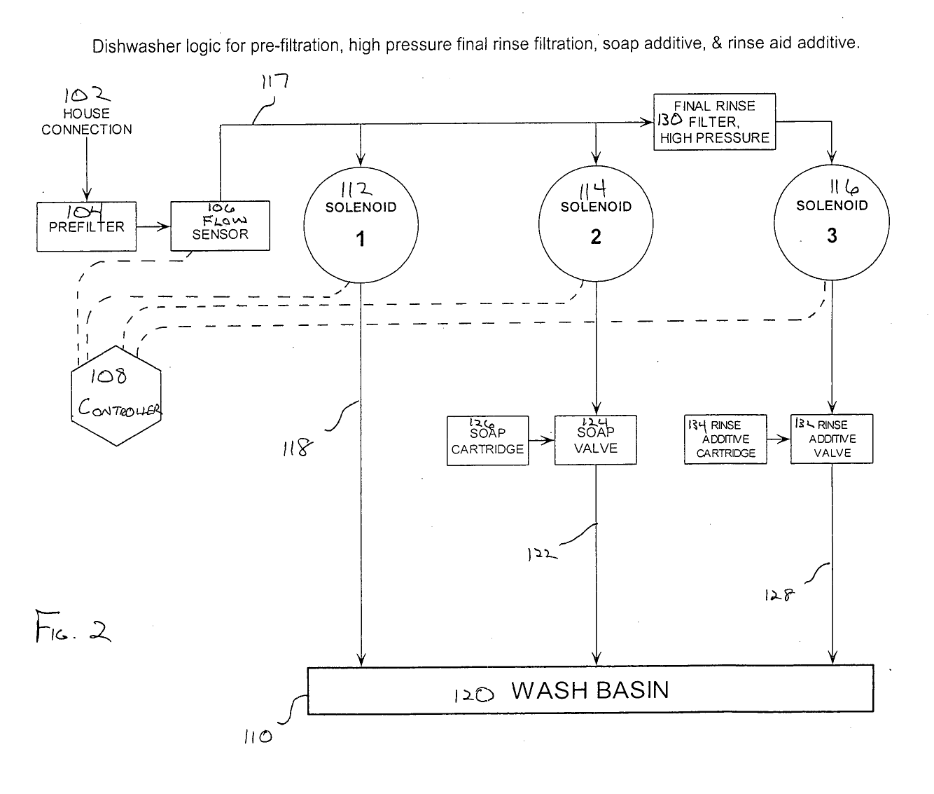

As illustrated in FIG. 1, fluid treatment system 100 can comprise a low-pressure configuration wherein final rinse filter 132 is protected from exposure to high pressure operating conditions through the placement of final rinse valve 116 between the final rinse filter 132 and the house connection 102. In an alternative configuration, a fluid treatment system 200 can comprise a high pressure configuration as illustrated in FIG. 2. In a high pressure configuration, final rinse filter 132 is exposed to static high pressure conditions as the closure of final rinse valve 116 results in final rinse filter 132 experiencing the same static high pressure condition as prefilter 104. In some presently preferred representative embodiments, the low pressure configuration of fluid treatment system 100, as shown in FIG. 1, can have advantages in that final rinse filter 132 could be fabricated with a less robust design than required for the high pressure configuration of fluid treatment system 200. A less robust design can result in final rinse filter 132 costing less to manufacture.

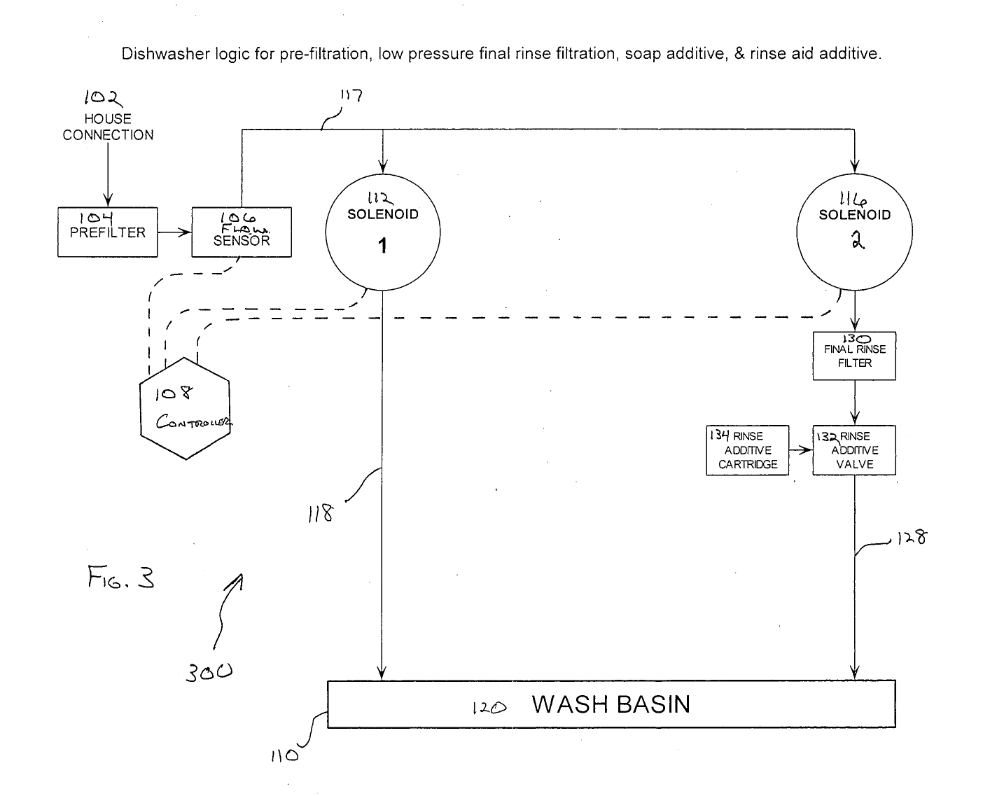

In addition to the high and low pressure configurations previously described, a number of alternative system configurations are presently contemplated. For example, either fluid treatment system 100 or fluid treatment system 200 can be redesigned without selected components present while still providing functional systems. Examples of variations to fluid treatment system 100 are illustrated in FIGS. 3 and 4. For instance, a fluid treatment system 300 illustrated in FIG. 3 substantially resembles fluid treatment system 100 with the exception that the soap flow line 122 has been completely removed. When washing appliance 110 incorporates fluid treatment system 300, wash soap can be added either manually or as a soap additive system configured physically separate from fluid treatment system 300. As illustrated in FIG. 4, a fluid treatment system 400 substantially resembles fluid treatment system 100 with the exception that the rinse additive valve 132 and rinse additive cartridge 134 are not present within the system. When washing appliance 110 incorporates fluid treatment system 400, rinse additive can be added either manually or as a rinse additive system set apart from fluid treatment system 400. In other presently preferred representative embodiments, fluid treatment systems can be designed with a detergent dispenser but no rinse aid dispenser.

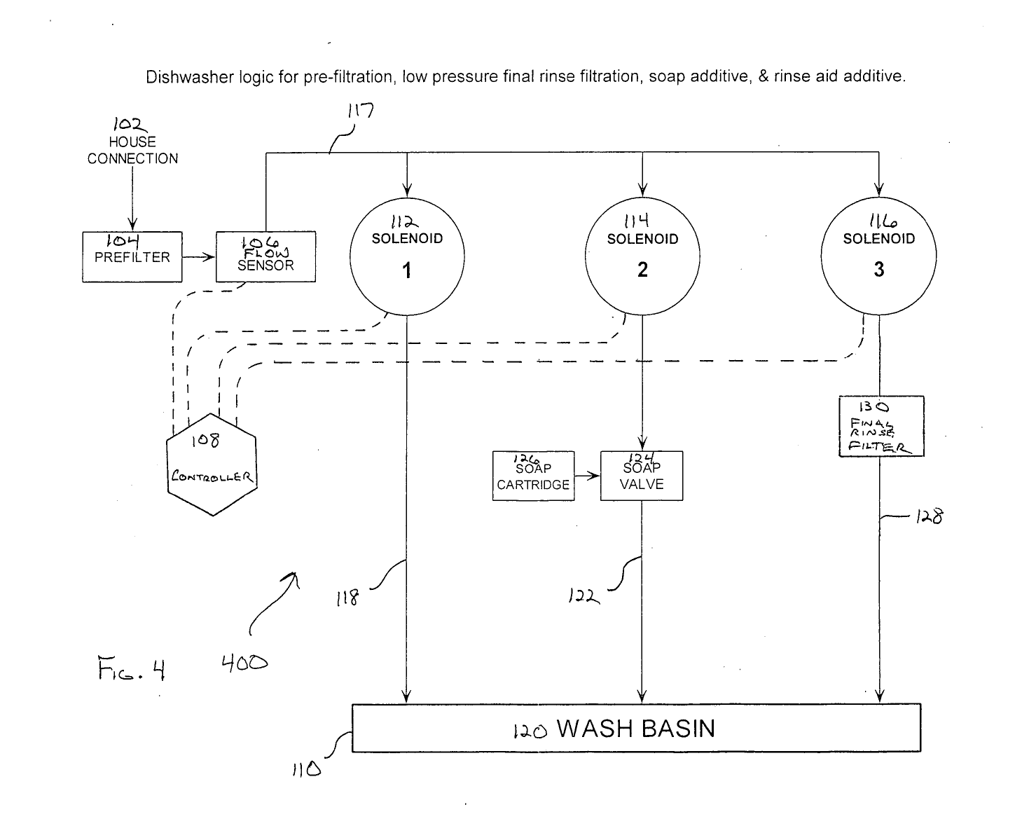

As described above, the fluid treatment system can be configured within or adjacent a wash appliance in alternative selected locations. As specific examples, a variety of physical embodiments of fluid treatment system 300 are illustrated in FIGS. 5, 6 and 7, corresponding with fluid treatment assembly shown in FIG. 3. As shown in FIGS. 5, 6 and 7, fluid treatment system 300 can physically comprise a manifold assembly 302 and a filter assembly 304. In some presently preferred representative embodiments, manifold assembly 302 can comprise a unitary structure incorporating various flow components such as, for example, house connection 102, flow sensor 106, prefiltered flow line 117, rinse solenoid 112, and final rinse solenoid 116 into a single flow structure. Manifold assembly 302 can further comprise a mounting shroud 306. Though not depicted, it is to be understood that controller 108 is located separately from fluid treatment system 300.

As illustrated in FIG. 5, filter assembly 304 can comprise a unitary insertion structure 308 comprising prefilter 104, final rinse filter 130 and rinse additive cartridge 134. Unitary insertion structure 308 can further comprise a prefilter connector 310, a final rinse filter connector 312 and rinse additive cartridge connector 314 wherein said connectors slidingly connect into corresponding receivers within the mounting shroud 306 such that the unitary insertion structure 308 is fluidly engaged to the manifold assembly 302. Manifold assembly 302 and filter assembly 304 can comprise suitable sealing members such as, for example, 0-rings present on either or both of manifold assembly 302 and filter assembly 304, such that couplable engagement of the manifold assembly 302 and filter assembly 304 results in fluid treatment system 300 being essentially leak proof during operation. Representative slidable interconnection methods and structures for the prefilter connector 310, final rinse filter connector 312, rinse additive cartridge connector 314 and the corresponding shroud receivers are disclosed and described in U.S. Publication No. 2003-0024860 A1, which is herein incorporated by reference to the extent not inconsistent with the present disclosure. Unitary insertion structure 308 can further comprise a locking member 316 and a handle 318 for fixedly attaching and/or removing the unitary insertion structure 308 from the manifold assembly 304. In one presently preferred embodiment, unitary insertion structure 308 is manufactured such that prefilter 104, final rinse filter 130 and rinse additive cartridge 134 are designed to have roughly equivalent wash cycle capacities such that the capacities expire at roughly the same time and replacing the unitary insertion structure 308 provides equivalent, new capacities for each of the prefilter 104, final rinse filter 130 and rinse additive cartridge 134.

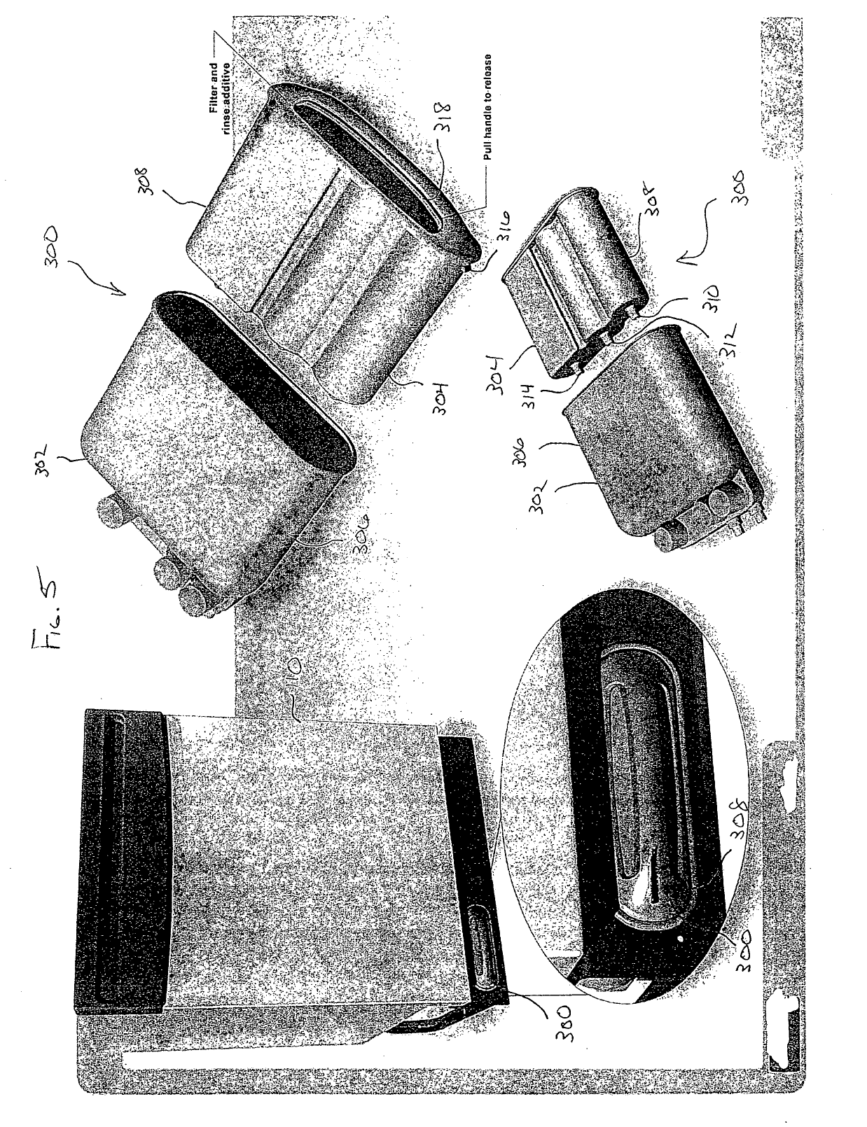

An alternative presently preferred representative embodiment is illustrated in FIG. 6. Fluid treatment system 300 comprises manifold assembly 302 and a plurality of individually replaceable elements including a prefilter cartridge 322 (corresponding to prefilter 104), a final rinse filter cartridge 324 (corresponding to final rinse filter 130), and a rinse additive cartridge 326 (corresponding to rinse additive cartridge 134). These individually replaceable elements can be configured to be individually, rotatably or slidably connectable with manifold assembly 302 to complete fluid circuits such as, for example, using methods and connecting apparatus as described in U.S. Pat. Nos. 6,649,056 and 6,953,526; and U.S. Publication Nos. 2003-0010698 A1, 2003-0019819 A1, and 2003-0217959 A1, all of which are herein incorporated by reference to the extent not inconsistent with the present disclosure. In some currently contemplated representative embodiments, rinse additive cartridge 326 can comprise an additive housing 328 and an additive reservoir 330.

As shown in FIG. 6, prefilter cartridge 322, final rinse filter cartridge 324 and rinse additive cartridge 326 are each capable of individual replacement and/or replenishment of their capacity. A display, indicator lights or other visual and/or audio signal can be used to inform the user of the need to replace a container and/or filter component. In one presently preferred embodiment, the use of individually replaceable prefilter cartridge 322, final rinse filter cartridge 324 and rinse additive cartridge 326 allow the capacity of each to be consumed without the concern that one or more of the prefilter cartridge 322, final rinse filter cartridge 324 and rinse additive cartridge 326 has remaining capacity while one has had its capacity exhausted. This provides additional design flexibility without concern of unnecessarily increasing the cost of replacing components.

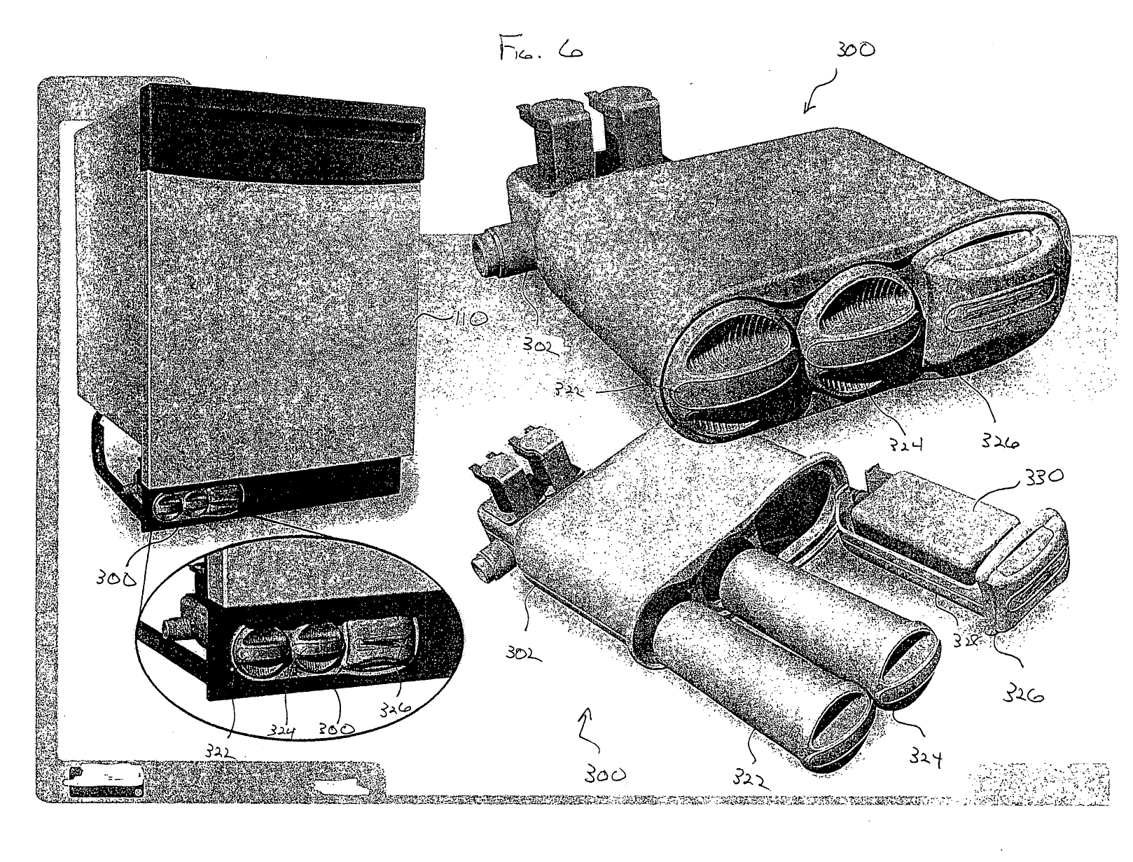

As illustrated in FIG. 7, the features of embodiments previously described with respect to FIGS. 5 and 6 have been combined to form another alternative configuration for fluid treatment system 300 incorporating manifold assembly 302 and further incorporating prefilter cartridge 322 and final rinse filter cartridge 324 into a unitary filter structure 330 while also incorporating rinse additive cartridge 326. In this manner, unitary filter structure 330 is capable of replacement separately from replacement or replenishment of the additive reservoir 318.

As illustrated in FIG. 8, a representative embodiment of a fluid treatment system 500 as contemplated within the present disclosure can comprise a manifold assembly 502, a rinse filter 504, a final rinse filter 506, a rinse additive assembly 508 and a detergent additive assembly 510. Rinse additive assembly 508 can comprise a rinse introduction 5 valve 512 and a rinse bag 514 while detergent additive assembly 510 can comprise a detergent introduction valve 516 and a detergent bag 518.

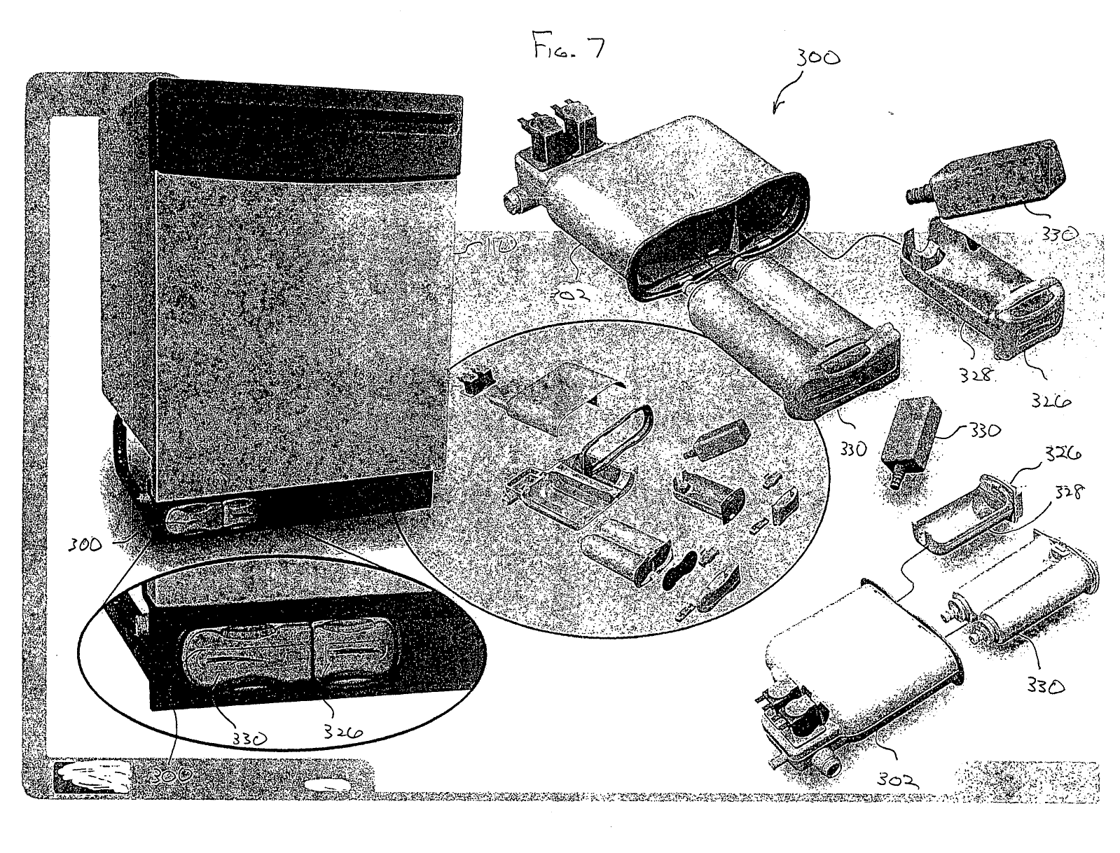

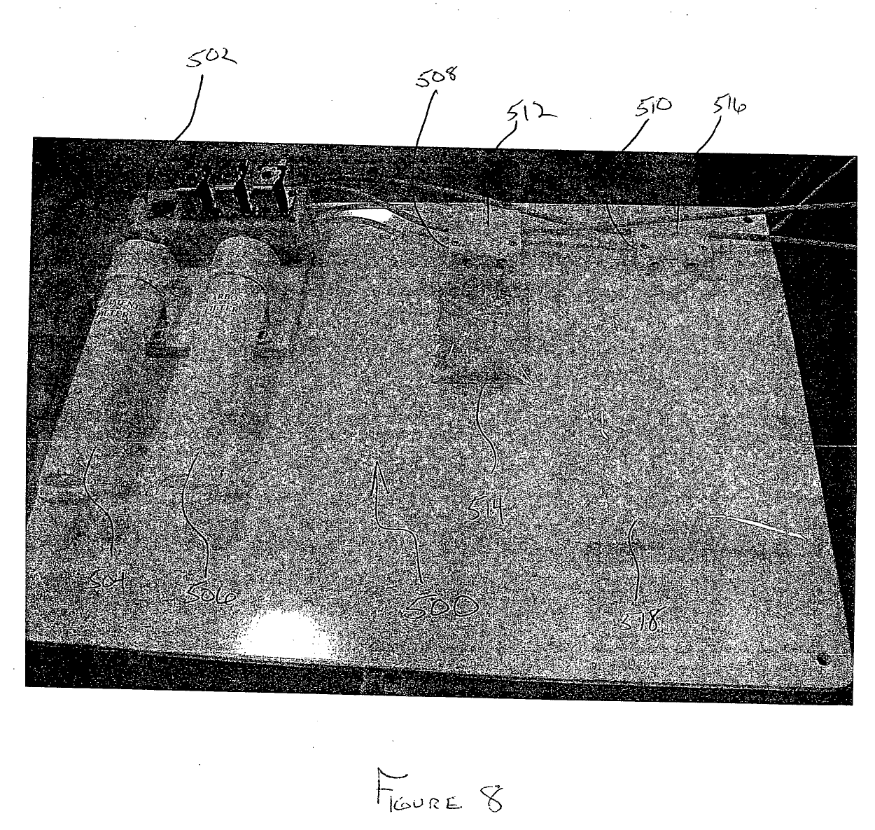

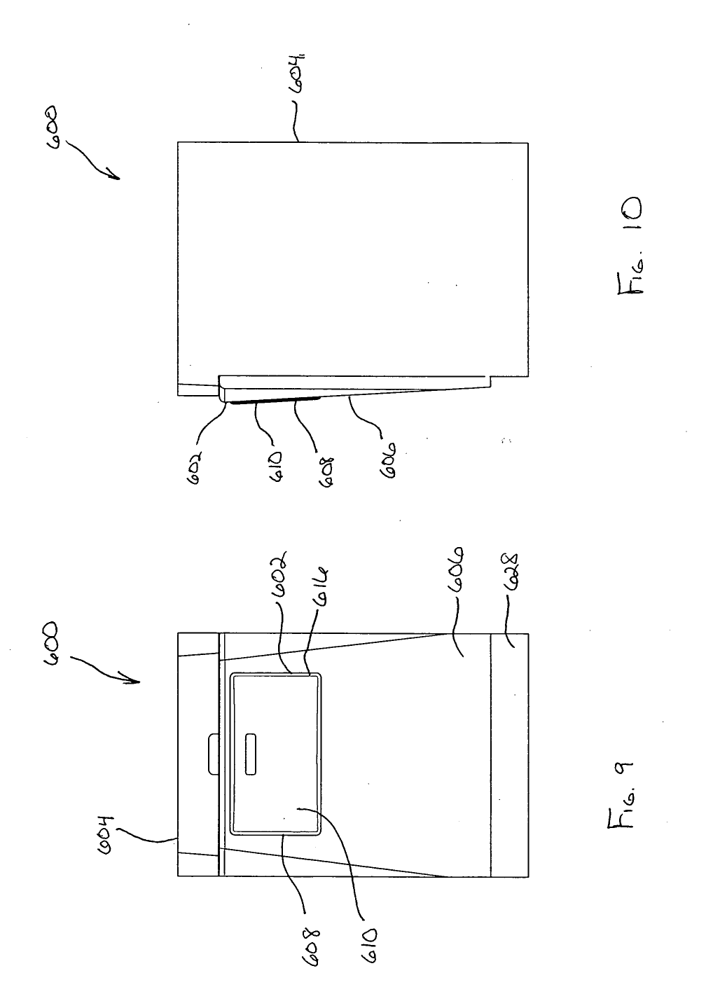

A washing appliance such as, for example, dishwasher 600 can comprise various configurations of fluid treatment systems as described herein in a door mount assembly 602 as illustrated in FIGS. 9-13. Generally, dishwasher 600 comprises a body 604 and a door 606. Dishwasher 600 can be fabricated for an under-counter installation or alternatively, a stand-alone installation and can comprise a number of suitable materials such as, for example, stainless steel and painted mild steel so as to be aesthetically pleasing in the surroundings in which it is installed.

With door mount assembly 602, door 606 is fabricated so as to comprise a fluid system compartment 608. Fluid system compartment 608 can comprise a compartment door 610 and an interior compartment 612. Compartment door 610 can be fabricated of suitable materials such as for example, polymeric materials such as polycarbonate or metals such as stainless steel and painted mild steel. Compartment door 610 can comprise a single, unitary piece or may comprise a plurality of vertically or horizontally arranged panels that are operably connected, for example, by individual hinging. Compartment door 610 can be configured to allow access to interior compartment 612 in a variety of ways including a hinged mount, either a top, bottom or side mounted hinge arrangement, a snap-in mount wherein the compartment door 610 is entirely removable from door 606 or a slide-in mount where compartment door is slidably inserted into an interior portion 614 of door 606. Compartment door 610 can be non-translucent, semi-translucent or translucent such that interior compartment 612 can be selectively viewable or non-viewable by an observer looking at door 606 with compartment door 610 in a closed disposition 616.

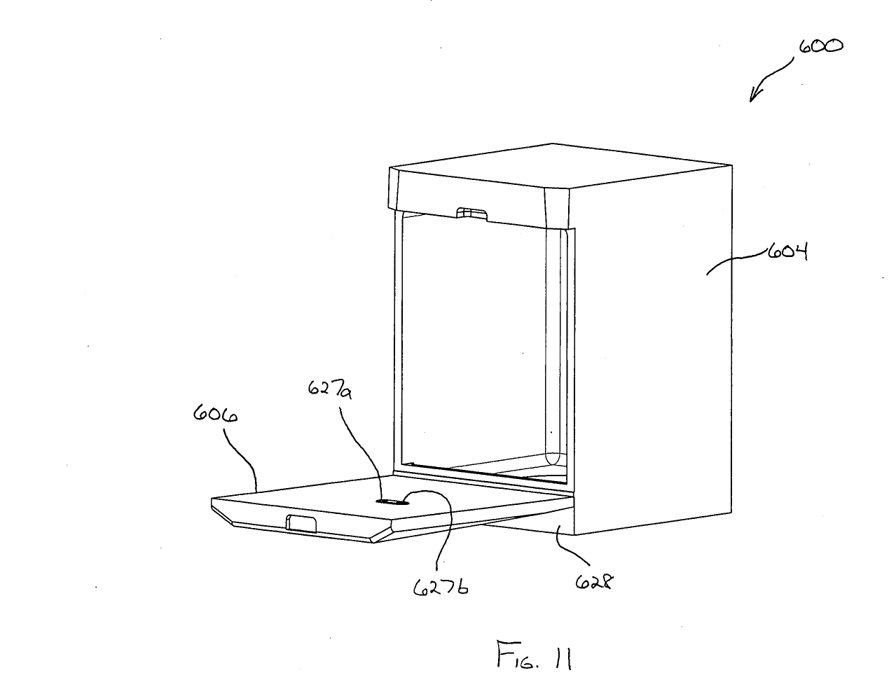

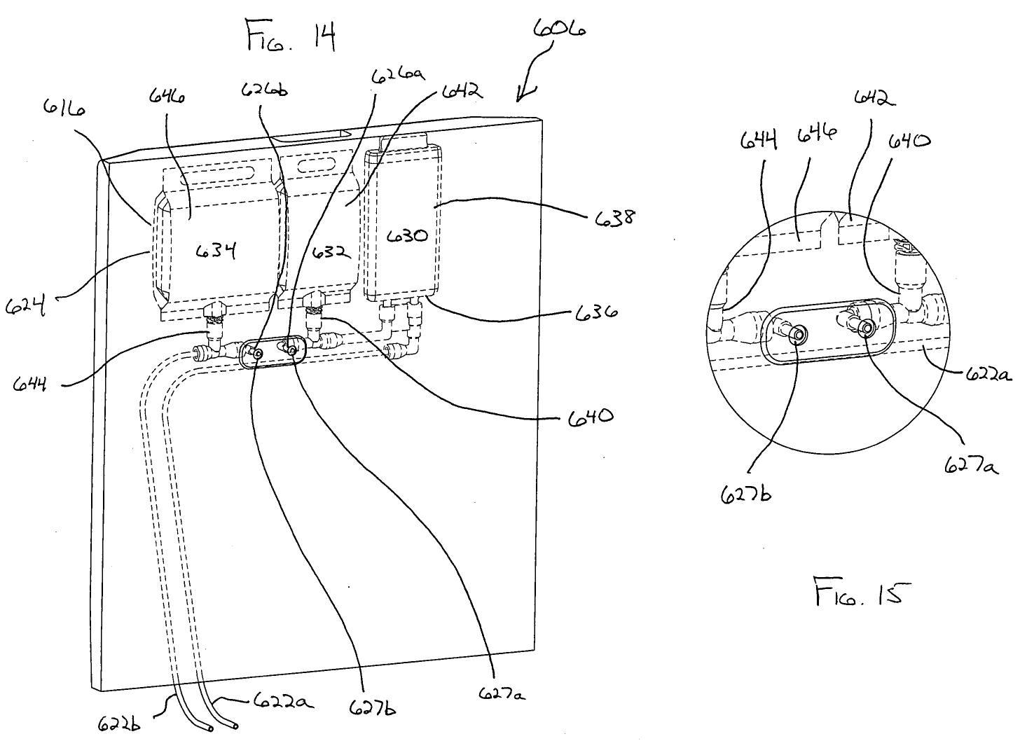

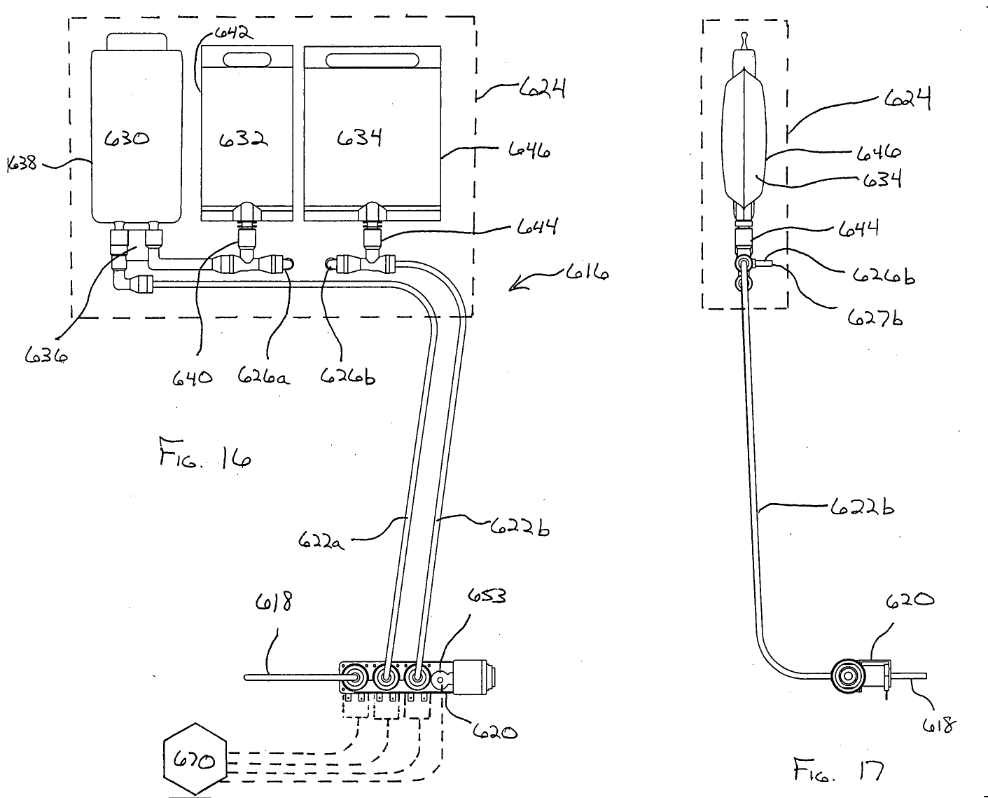

As illustrated in FIGS. 12 -17, a fluid treatment system 616 can be integrated within dishwasher 600 such that portions of fluid treatment system 616, for example portions including filtering and/or washing medium, that require periodic replenishment and/or replacement are accessible from door 606. In a representative embodiment further illustrated in FIGS. 16 and 17 removed from dishwasher 600, fluid treatment system 616 can comprise an inlet line 618, a distribution manifold 620, a pair of distribution lines 622a, 622b, a treatment assembly 624, a pair of dispensing lines 626a, 626b and a pair of dispensing ports 627a, 627b. In some representative embodiments, fluid treatment system 616 can comprise an integral system providing for generally simultaneous installation and placement within dishwasher 600. Alternatively, fluid treatment system 616 can comprise individual components that can be positioned and operably connected independently to promote advantageous system characteristics such as, reducing the width of door 606 and providing easy, unobstructed access to treatment assembly 624 through compartment door 610. As illustrated in FIGS. 12 and 13, positioning the treatment assembly 624 and various fluid lines within compartment door 610 does not substantially increase the width of door 610. At the same time, distribution manifold 620 which may require infrequent inspection and repair can be accessible through a bottom panel structure 628 such that said inspection and repair does not require disassembly of door 610.

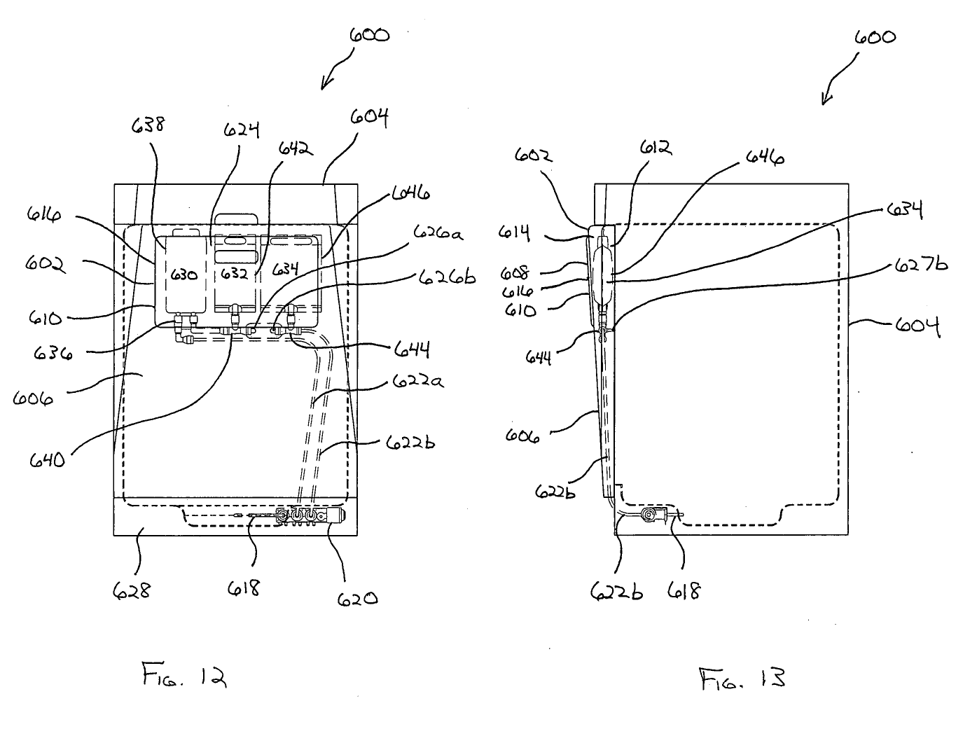

Fluid treatment system 616 can comprise a wide variety of alternative arrangements such as, for example, the type of source water (either municipally treated or well water) as well as the pricing and/or quality level of dishwasher 600. As illustrated in FIGS. 12 and 14, fluid treatment system 616 can comprise a prefilter assembly 630, a wash additive assembly 632 and a rinse additive assembly 634. Prefilter assembly 630 can comprise a prefilter manifold 636 and a prefilter cartridge 638. Prefilter cartridge 638 can comprise a variety of replaceable configurations for interfacing with prefilter manifold 636 such as, for example, rotatably replaceable configurations, slidably replaceable configurations or combinations of rotatable and slidable configurations. Prefilter 638 can comprise a variety of filtration medias for removing contaminants such as, for example, particulate matter, dissolve solids, organic matter and the like from a fluid stream prior to use in dishwasher 600. Suitable filtration media can comprise media such as, for example melt blown polyethylene, pleated filters, and filters sold under the trade designation POLY CLEAN, available from CUNO Inc., Meriden, Conn.

Wash additive assembly 632 can comprise wash additive introduction member 640 and a wash additive reservoir 642. Rinse additive assembly 634 can comprise a rinse additive introduction member 644 and a rinse additive reservoir 646. Wash additive introduction member 640 and rinse additive introduction member 644 can comprise any of a variety of suitable introduction members such as, for example, fixed venturi injectors, adjustable venturi injectors and hydraulic injectors, all of which will be further described and discussed below. Wash additive reservoir 642 and rinse additive reservoir 646 can comprise suitable refillable assemblies or can comprise disposable reservoirs, such as bags or generally rigid containers. Wash additive reservoir 642 can contain soap, detergents and/or sanitizers in either a liquid, powdered or solid form. Rinse additive reservoir 646 can comprise a suitable rinse aid such as, for example, a spot-free rinse aid or sanitizer.

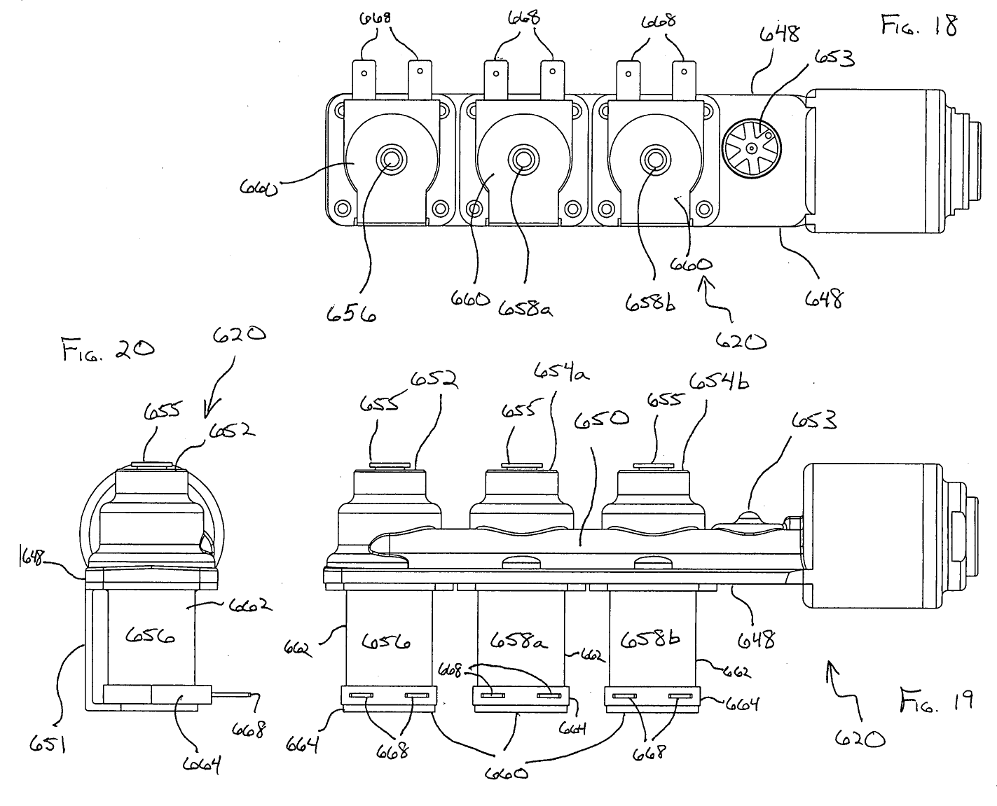

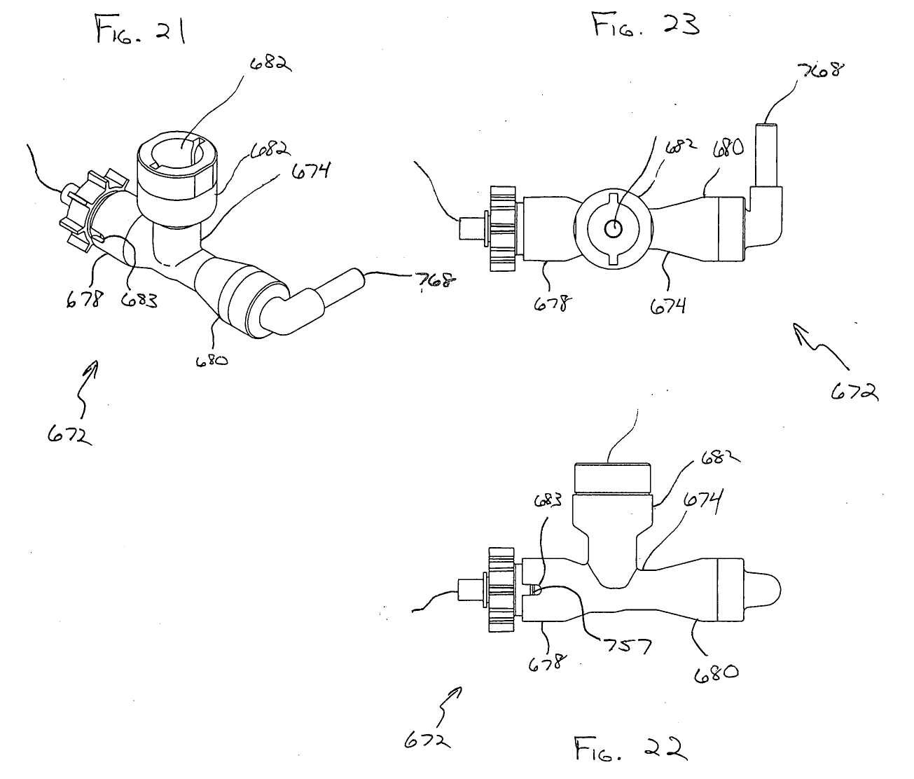

Distribution manifold 620 is more clearly illustrated in FIGS. 18, 19 and 20. Distribution manifold 620 generally comprises a distribution manifold body 648 having an internal distribution flow channel 650 and a manifold mounting bracket 651. A flow sensor 653 can be operably, fluidly mounted to distribution manifold body 648 so as to sense and monitor fluid flow rates through the internal distribution flow channel 650. Flow sensor 653 can comprise suitable flow sensors such as, for example, paddlewheel sensors, turbine sensors, hall effect sensors available from companies such as, for example, Gem Sensors Inc., of Plainville, Conn., Global Water Instrumentation, Inc., of Gold River, Calif. and Omega Engineering, Inc., of Stamford, Conn.

Internal distribution flow channel 650 operably fluidly interconnects a manifold inlet 652 and a pair of manifold outlets 654a, 654b. In some presently contemplated embodiments, a tube fitting 655 can be operably, fluidly mounted within manifold inlet 652 and manifold outlets 654a, 654b to provide for easy coupling with tubing, for example, polymer, stainless steel or copper tubing, used to form inlet line 618 and distribution lines 622a, 622b. An inlet valve 656 is operably, sealably mounted to distribution manifold body 648 so as to control flow through manifold inlet 652 while a pair of outlet valves 658a, 658b are operably, sealably mounted to the distribution manifold body 648 to control flow through the corresponding manifold outlet 654a, 654b.

Inlet valve 656 and outlet valves 658a, 658b can comprise suitable actuatable valves for use with fluid streams such as, for example, electrically actuated valves, for example solenoid valves 660 as depicted in FIGS. 18, 19 and 20, pneumatically actuated valves or hydraulically actuated valves. Representative solenoid valves 660 can comprise solenoid valves available from companies such as, for example, Emerson Industrial Automation's ASCO® division headquartered in Florham Park, N.J.; Parker-Hannifin Corporation of Mayfield Heights, Ohio and Omega Engineering, Inc., of Stamford, Conn. Each solenoid valve 660 can comprise a valve body 662 and an actuator portion 664. Actuator portion 664 further comprises an electrical socket portion 668 for operably, electrically interconnecting solenoid valve 660 with a controller 670 as illustrated in FIG. 16.

Controller 670 can comprise any suitable controller suitable for receiving flow information from flow sensor 653 as well as selectively actuating inlet valve 656 and outlet valves 658a, 658b such as, for example, electrical relay based controllers, Programmable Logic Controllers (PLC's) or microprocessor based controllers. Controller 670 can be remotely located from fluid treatment system 616, for example a stand-alone whole home control or in another appliance such as a refrigerator or alternatively, controller 670 can be in physical proximity to fluid treatment system 616 such as, for example, a dishwasher controller within either body 604 or door 606.

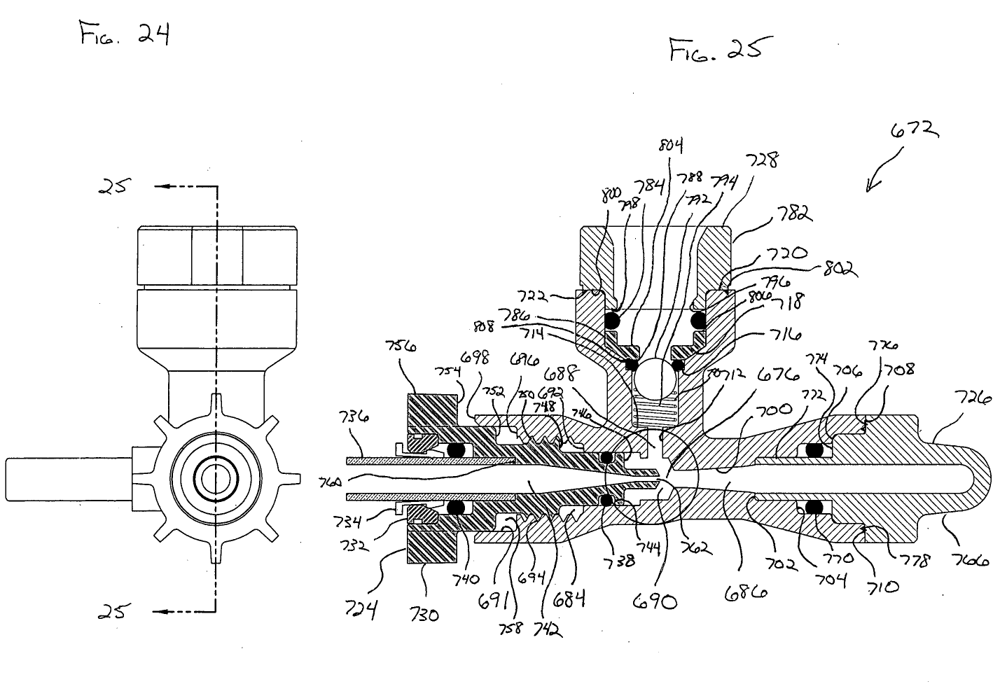

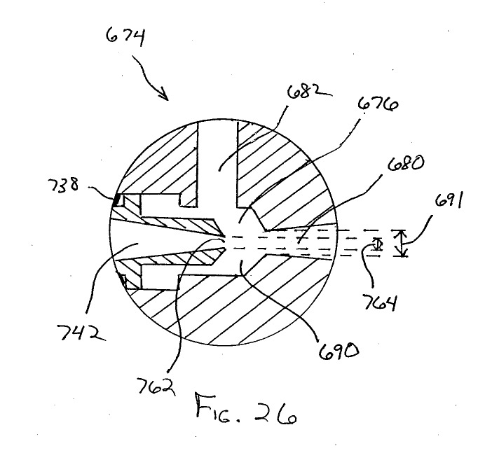

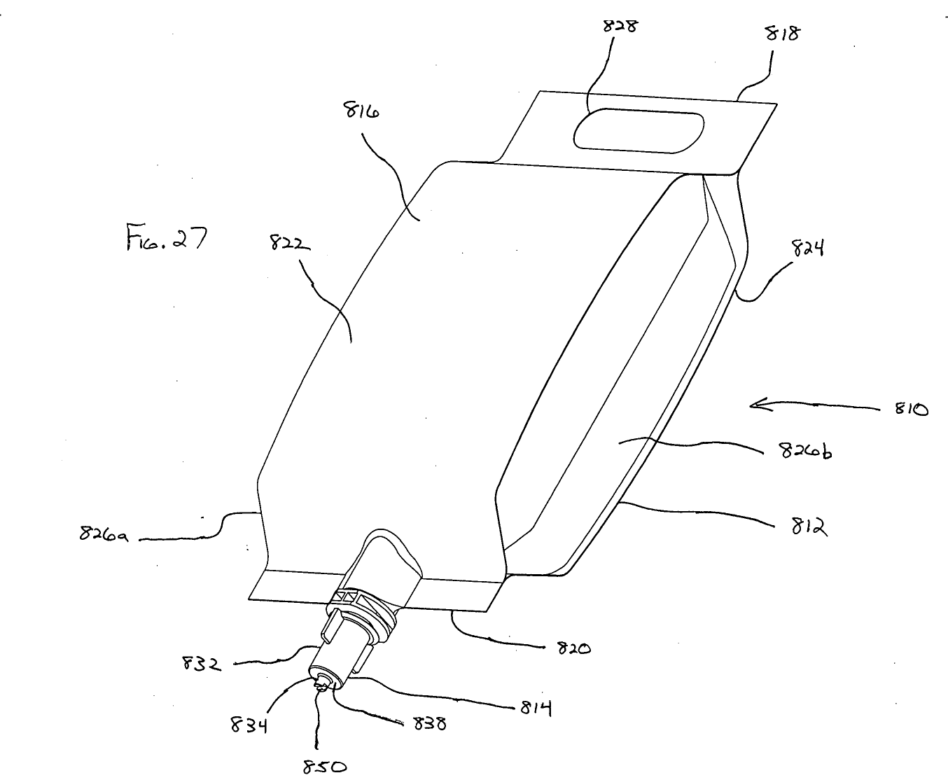

As discussed previously, wash additive introduction member 640 and rinse additive introduction member 644 can comprise any of a variety of suitable introduction members such as, for example, fixed venturi injectors, adjustable venturi injectors, hydraulic injectors, or combinations thereof. A representative adjustable venturi injector assembly 672 is illustrated in FIGS. 21-26. Adjustable venturi injector assembly 672 generally comprises an adjustable venturi body 674 having a venturi flow channel 676 operably, fluidly interconnecting an injector inlet portion 678, an injector outlet portion 680 and an additive inlet portion 682. Injector inlet portion 678 can comprise a viewing notch 683. Venturi body 674 can comprise a unitary body structure fabricated from suitable materials such as, for example, molded polyolefin materials or suitable metals.

Venturi flow channel 676 generally comprises an inlet flow portion 684, an outlet flow portion 686, an additive flow portion 688 and a mix portion 690. Outlet flow portion 686 has an outlet flow diameter 691 proximate the mix portion 690. Inlet flow portion 684 is generally defined by an inlet internal perimeter surface 691 having an insertion depth flange 692, a circumferential thread 694, an abutment flange 696 and an exterior flange 698. Outlet flow portion 686 is generally defined by an outlet internal perimeter surface 700 having a first abutment flange 702, a sealing flange 704, a second abutment flange 706 and a sealing flange 708. Sealing flange 708 can comprise a circumferential cavity or groove 710. Additive flow portion 688 is generally defined by an additive internal perimeter surface 712 having a biasing flange 714, a sealing flange 716, a guiding surface 718 and a sealing flange 720. Sealing flange 720 can comprise a circumferential cavity or groove 722.

In addition to adjustable venturi body 674, adjustable venturi injector assembly 672 further comprises an adjustable inlet assembly 724, an outlet connection assembly 726 and an additive connection assembly 728. Adjustable inlet assembly 724 comprises an inlet connector body 730, a collet 732, a tube retainer 734, inlet tubing 736, a first inlet seal 738 and a second inlet seal 740. Inlet connector body 730 includes a tapered flow channel 742, an external seal groove 744, a first connector flange 746, a second connector flange 748, a circumferential thread 750, a third connector flange 752, a fourth connector flange 754, a biasing portion 756 and a depth indicator 757. Tapered flow channel 742 generally comprises a receiving cavity 758, a tube flange 760 and a tip opening 762 having a tip opening diameter 764.

Outlet connection assembly 726 can comprise an outlet connector body 766, outlet tubing 768 and an outlet seal 770. Outlet connector body 766 comprises a projecting portion 772, a first outlet flange 774 and an outlet sealing flange 776. Outlet sealing flange 776 can comprise a circumferential weld director 778. Outlet connector body 766 comprises an outlet flow channel 780 fluidly interconnecting the projecting portion 772 and the outlet tubing 768.

Additive connection assembly 728 can comprise an additive connector body 782, a first additive seal 784, an interface seat 786, a second additive seal 788 and an additive check valve 790. Additive check valve 790 can comprise a ball 792 and spring 794. Additive connector body 782 can comprise a projecting portion 796, a first connector flange 798, a second connector flange 800 and a circumferential weld director 802. Interface seat 786 can comprise a seating flange 804, a first sealing flange 806 and a second sealing flange 808.

In use, adjustable venturi injector assembly 672 provides a user with an adjustment mechanism for varying the amount of additive such as, for example, detergent or rinse aid, added into a fluid stream. In some embodiments, adjustable venturi injector assembly 672 allows for the amount of additive to be advantageously set based upon a water type or quality that is being used as the primary wash fluid. For instance, the amount of additive necessary for successful cleaning, sanitizing and/or rinsing can vary dependent upon whether the water is from a municipal or well water source and/or based on the amount of dissolved solids present within the wash fluid such as, for example, hardness and/or iron.

Assembly of adjustable venturi injector assembly 672 is generally accomplished to form the structure as shown in FIGS. 21-23 and 25. Outlet connector body 766 is fluidly attached to injector outlet portion 680 through insertion of projecting portion 772 into the outlet flow portion 686 in which outlet seal 770 is compressed between the projecting portion 772 and first outlet flange 774 of the outlet connector body 766 and the sealing flange 704 and outlet internal perimeter surface 700 of the outlet flow portion 686. If it is desired to permanently connect the outlet connector body 766 to the adjustable venturi body 674, sonic welding can be used to cause circumferential weld director 778 to melt and flow into circumferential groove 710 wherein outlet connector body 766 and adjustable venturi body 674 are permanently joined upon cooling. Alternatively, other joining methods such as, for example, friction welding, thermal processes such as hot plate welding or adhesive bonding can be used, either individually or in combination, to permanently join outlet connector body 766 and adjustable venturi body 674.

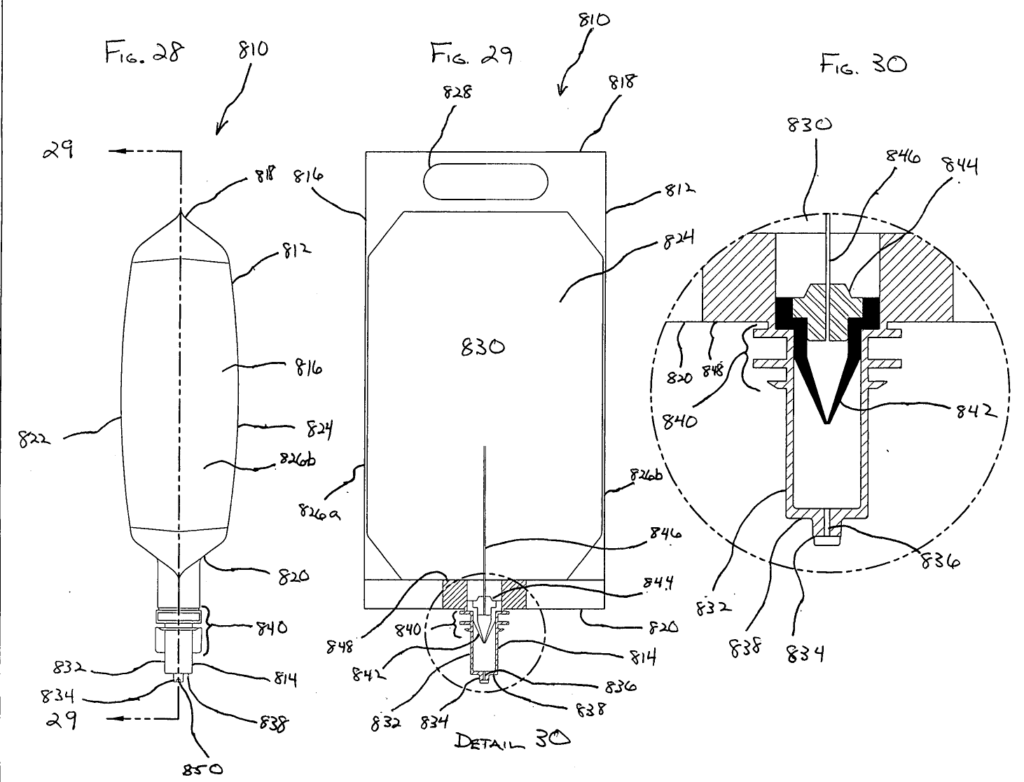

Additive inlet portion 682 is assembled and fluidly attached to additive connection assembly 728 by positioning spring 794 within additive flow portion 688 such that spring 794 resides against biasing flange 714, as shown in FIG. 25. Ball 792 is positioned proximate spring 794 such that second additive seal 788 and interface seat 786 retain check valve 790 while simultaneously forming a fluid tight seal between ball 792 and second additive seal 788. First additive seal 784 is positioned against first sealing flange 806 and projecting portion 796 of additive connector body 782 is placed within additive flow portion 688. If it is desired to permanently connect the additive connector body 782 to the adjustable venturi body 674, sonic welding can be used to cause circumferential weld director 802 to melt and flow into circumferential groove 722 wherein additive connector body 782 and adjustable venturi body 674 are permanently joined upon cooling. Alternatively, other joining methods such as, for example, friction welding, thermal processes such as hot plate welding or adhesive bonding can be used, either individually or in combination, to permanently join additive connector body 782 and adjustable venturi body 674.

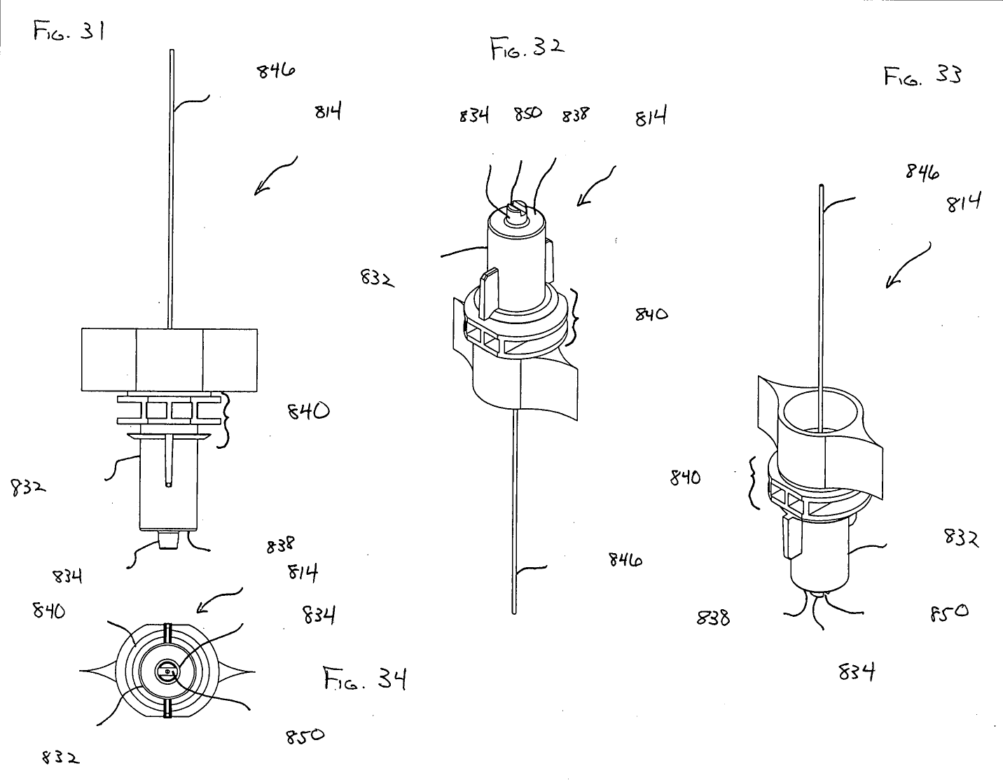

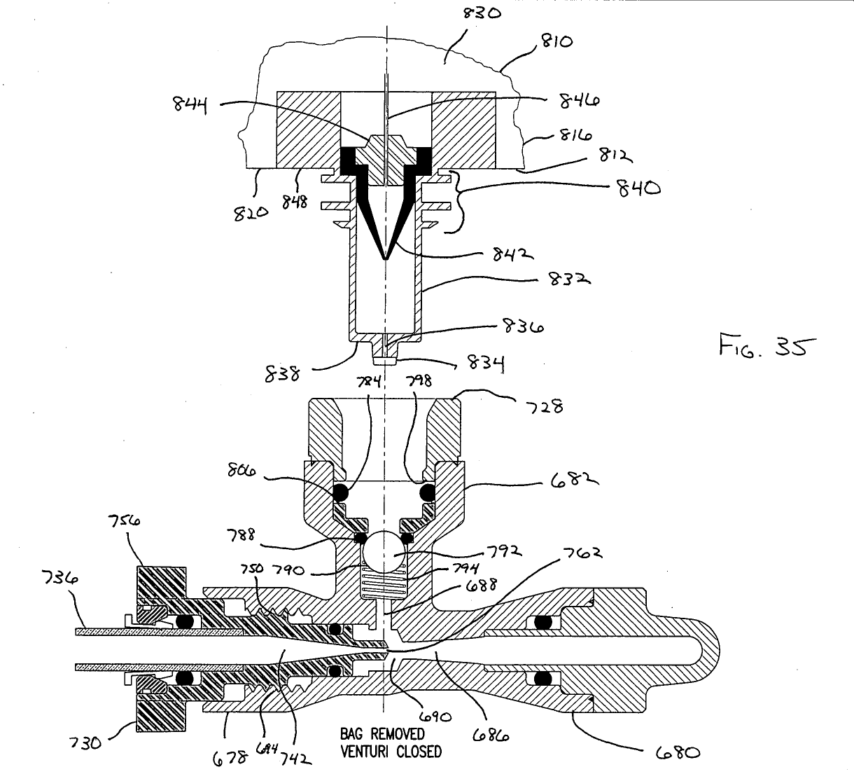

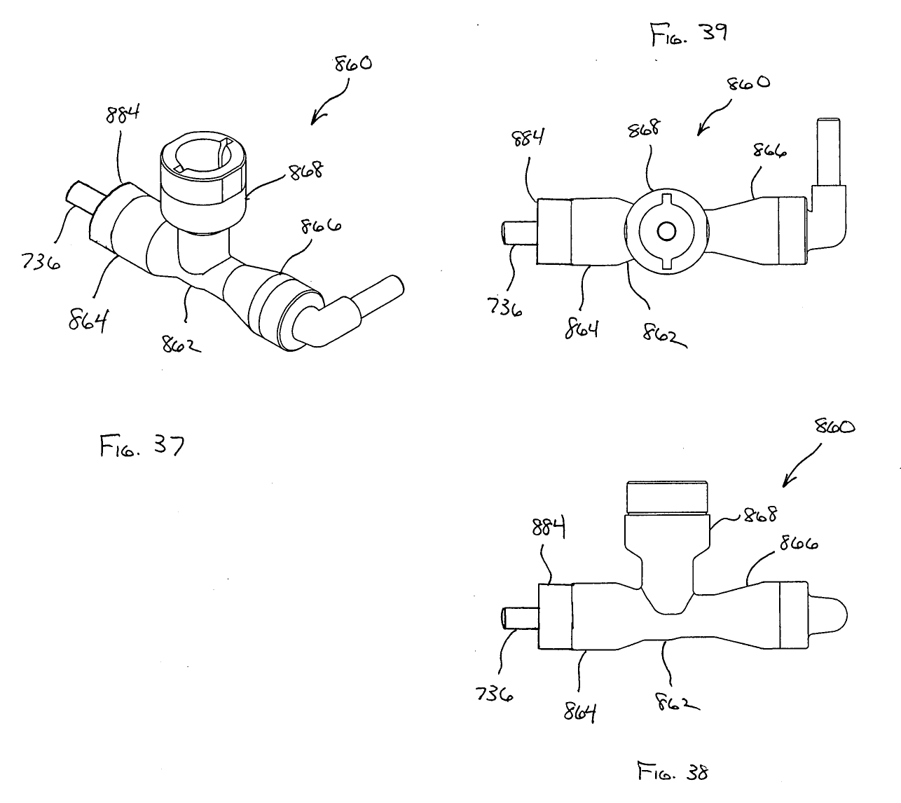

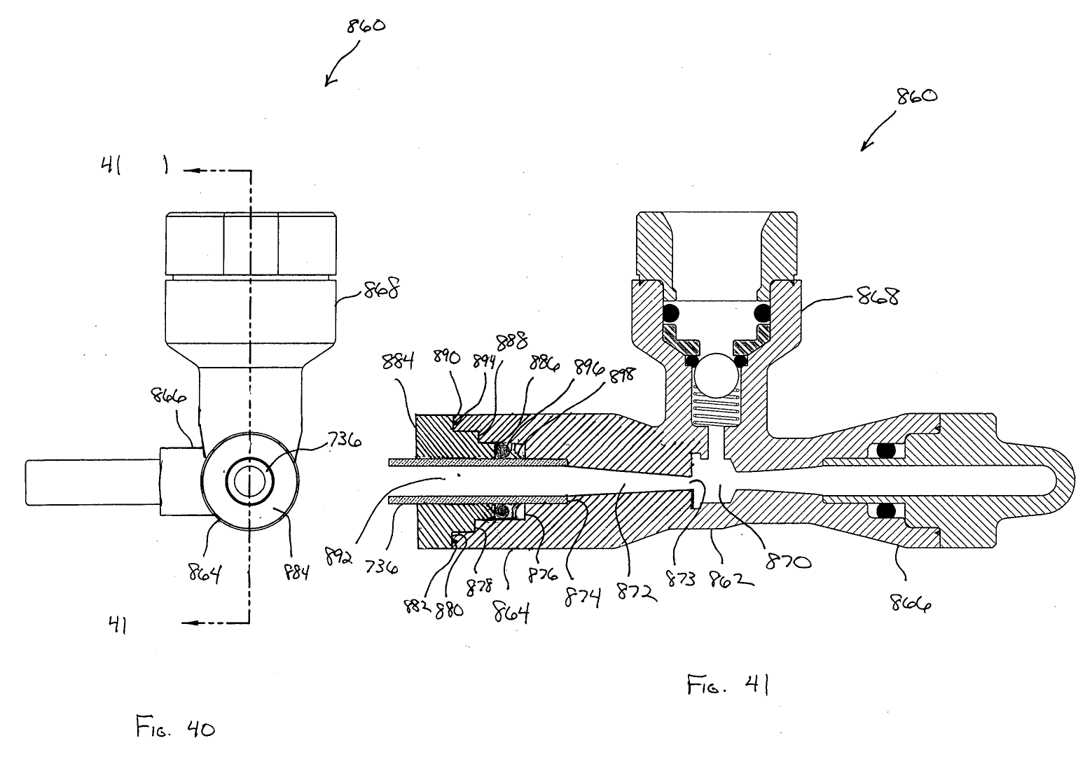

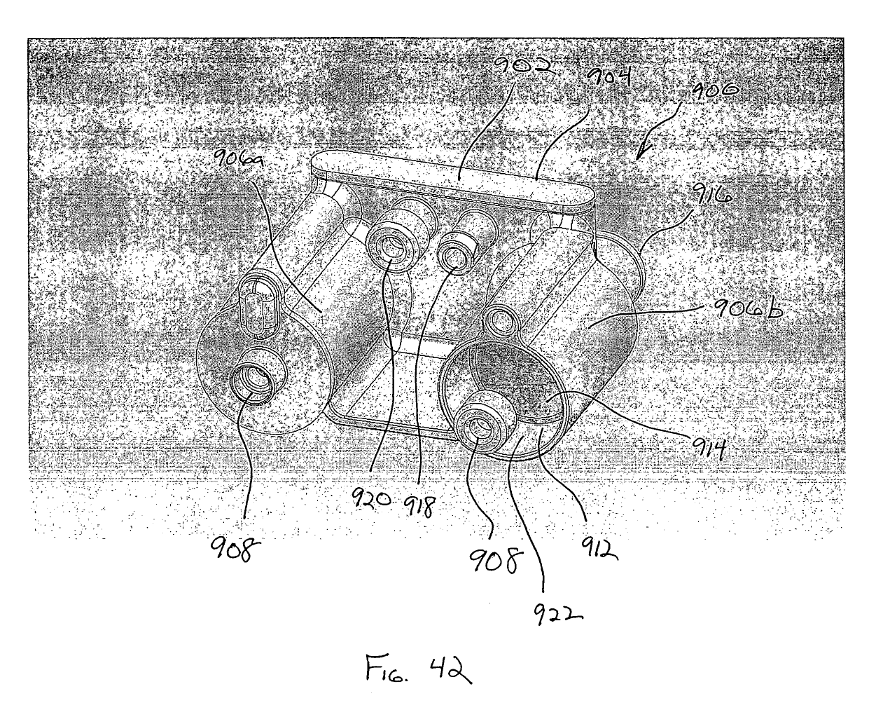

A representative additive assembly 810 for use with adjustable venturi injector assembly 672 is illustrated in FIGS. 27-33. Additive assembly 810 generally comprises an additive reservoir 812 and a dispenser assembly 814. Additive reservoir 812 can comprise a variety of alternative configurations such as, for example, a flexible bag 816 as illustrated or a rigid container (not depicted). Additive reservoir 812 generally comprises a handling end 818 and a dispensing end 820. Flexible bag 816 can be constructed by operably joining a top surface 822 and a bottom surface 824 and can further comprise opposed side walls 826a, 826b. Handling end 818 can comprise a grasping portion 828 for making handling of additive reservoir 812 easier for a user. Flexible bag 816 generally defines an internal volume 830 for storing a suitable additive such as, for example, a detergent, sanitizer and/or rinse aid.

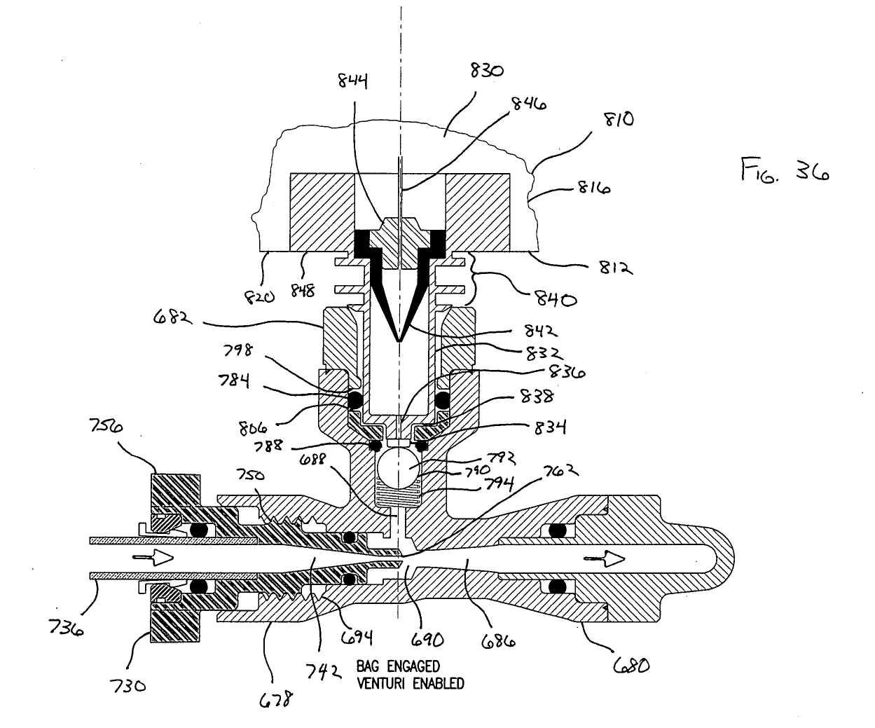

Dispenser assembly 814 is generally, operably mounted within the dispensing end 820, as shown in FIGS. 27-30. Dispenser assembly 814 can be formed within dispensing end 820 using a suitable molding process such as, for example, an insert molding, a thermal process such as, for example, hot plate welding, or an adhesive process. Dispenser assembly 814 generally comprises a dispenser body 832 having a dispensing tip 834, a tip fluid channel 846, a tip insertion flange 838, a mounting structure 840, a check valve 842, a valve mount 844, a valve channel 846 and a mounting portion 848. Dispensing tip 834 further comprises a notched flow channel 850. Check valve 842 can comprise a suitable valve design such as, for example, the illustrated duckbill valve in FIGS. 29 and 30 for preventing reverse flow into flexible bag 816.

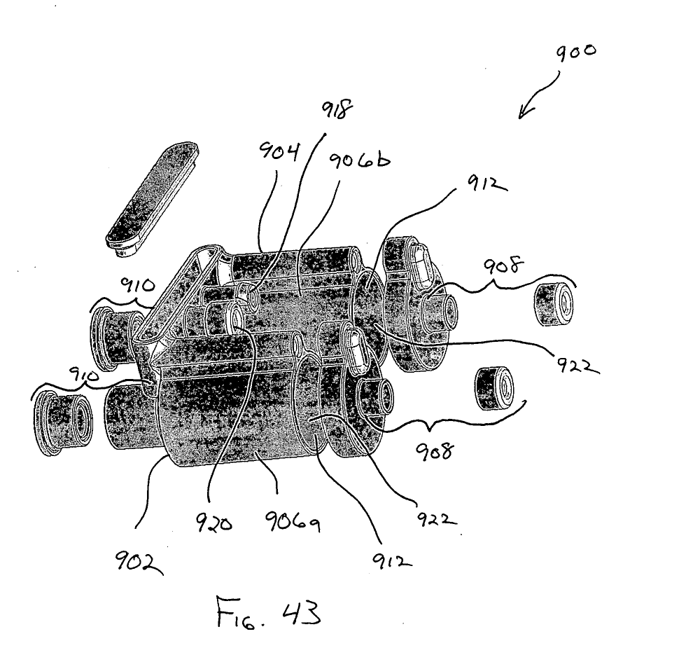

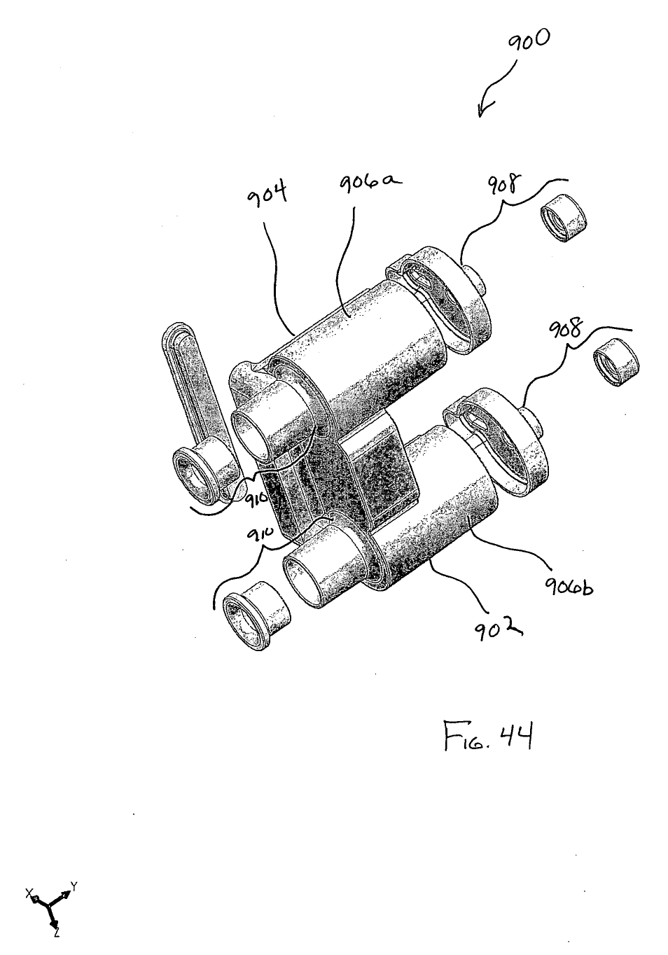

Use and operation of adjustable venturi injector assembly 672 in a representative fluid treatment system such as, for example, fluid treatment system 616 is described with reference to additive assembly 810 comprising a rinse aid within internal volume 830. Additive assembly 810 interfaces with adjustable venturi injector assembly 672 for selectively adding the rinse aid as illustrated in FIGS. 35 and 36. It is to be understood that the adjustable venturi injector assembly 672 of FIGS. 35 and 36 is operably, fluidly connected to a fluid source and dishwasher such as, for example, dishwasher 600. Generally, dispenser assembly 814 is positioned such that dispensing tip 834 is in proximity to and aligned with additive connection assembly 728, and more specifically aligned for insertion within additive connector body 782. Dispenser body 832 is then inserted such as, for example, slidingly or rotatably inserted into additive connector body 782 such that dispensing tip 834 is positioned proximate ball 792. Upon the complete insertion of dispenser body 832 within the additive connection assembly 728, the dispensing tip 834 is positioned proximate the ball 792 however, the fluid tight seal between ball 792 and second additive seal 788 remains unbroken such that no fluid pathway exists from between additive assembly 810 and additive flow portion 688. At the same time, a fluid tight seal is established by compressing first additive seal 784 between first connector flange 798, first sealing flange 806, additive inlet portion 682 and dispenser body 832.

During operation of dishwasher 600, a designated cycle such as, for example, a rinse cycle can be initiated such that a fluid flow is directed into the injector inlet portion 678 of adjustable venturi injector assembly 672 as illustrated in FIG. 36. The fluid flow exits inlet tubing 736 and enters tapered flow channel 742, wherein the cross-section of tapered flow channel 742 gets smaller and smaller as the fluid flow approaches tip opening 762 such that the velocity of the fluid flow increases as the fluid flow approaches tip opening 762. The fluid flow exits tip 762 at a maximum velocity into the mix portion 690 wherein the fluid flow enters the outlet flow portion 686. As the fluid flow exits tip 762 at maximum velocity, a vacuum is formed within additive flow portion 688 causing ball 792 to compress spring 794 such that the check valve 790 is in an open disposition as illustrated in FIG. 36. When check valve 790 is in an open disposition, an operable flow path is established between additive reservoir 812 and mix portion 690. The vacuum created within mix portion 690 causes a flow or rinse aid to be drawn from the flexible bag 816, through valve channel 846, check valve 842, and tip fluid channel 836 wherein the rinse aid flows into additive flow portion 688 for mixing with the fluid flow in mix portion 690. In this manner, the now mixed fluid flow and rinse aid is delivered to dishwasher 600 through injector outlet portion 680 and outlet tubing 768. Through the use of check valve 790 and check valve 842, fluid flow is prevented from backflowing into flexible bag 816 in the event that an obstruction or other problem is experienced downstream of outlet flow portion 686. Following completion of the rinse cycle, fluid flow into the injector inlet portion 678 is stopped such that venturi induced vacuum on check valve 790 is eliminated causing spring 794 to reseat ball 792 against second additive seal 788 such that further introduction of rinse aid into the mix portion 690 is prevented.

Depending upon water quality such as, for example, a municipal water source versus a well water source, the amounts of rinse aid needed to achieve a desired rinse quality can vary. Rinse aid amounts can vary depending on factors such as, for example, the amount of iron and/or hardness present within the rinse fluid. Through the use of adjustable venturi injector assembly 672, the amount of rinse aid dispensed can be varied by selectively adjusting the amount of vacuum generated within mix portion 690. For example, if more rinse aid is desired, a higher vacuum can be drawn on additive flow portion 688 by maximizing the velocity of the fluid flow. The dispensing of a greater amount of rinse aid can be accomplished through positioning the tip opening 762 closer to the outlet flow portion 686. With the increased vacuum, more rinse aid is drawn from flexible bag 816. Alternatively, if less rinse aid is necessary, tip opening 762 can be positioned farther away from the outlet flow portion 686 such that the amount of vacuum generated on additive flow portion 688 is reduced.

Selective positioning of the tip opening 762 can be accomplished through manual rotation of the biasing portion 756. As biasing portion 756 is manually turned, circumferential thread 750 of inlet connector body 730 engages the circumferential thread 694 of the inlet flow portion 684. Interaction of circumferential thread 750 and circumferential thread 694 causes the position of tip opening 762 to vary with respect to the outlet flow portion 686. To facilitate positioning of the tip opening 762, a user can view the depth indicator 757 on inlet connector body 730 through the viewing notch 683. In this manner, a user can selectively rotate the connector body 730 such that tip opening 762 is appropriately positioned. The positioning of tip opening 762 can be accomplished in some representative embodiments prior to installation of a representative fluid treatment system such as, for example, fluid treatment system 616 within an appliance such as, for example, dishwasher 600, or alternatively, tip opening 762 can be positioned following installation of an appliance at a place of use such as, for example, a residence or business.

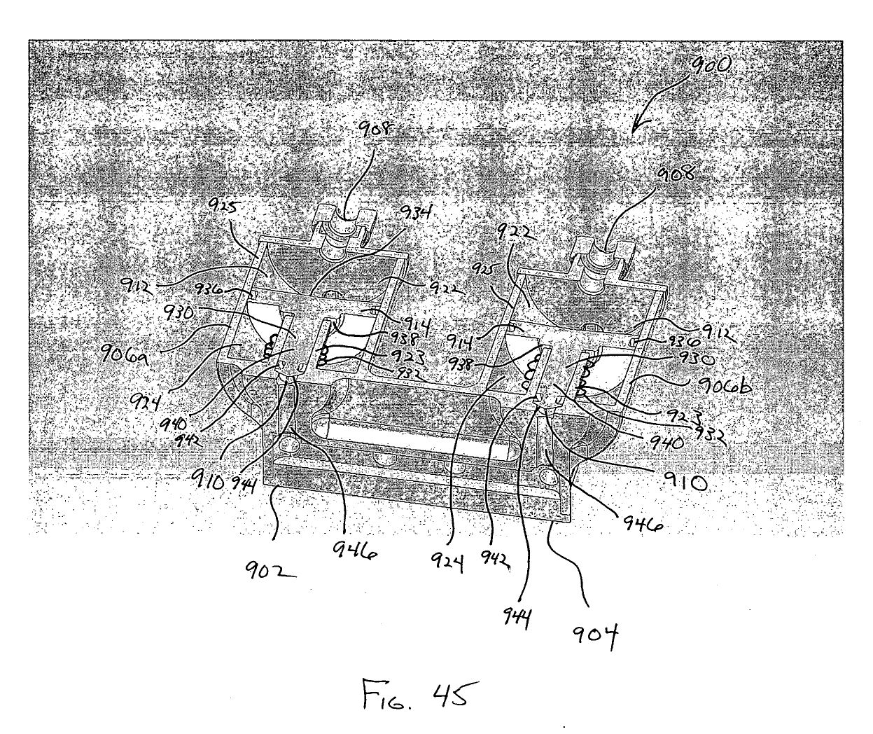

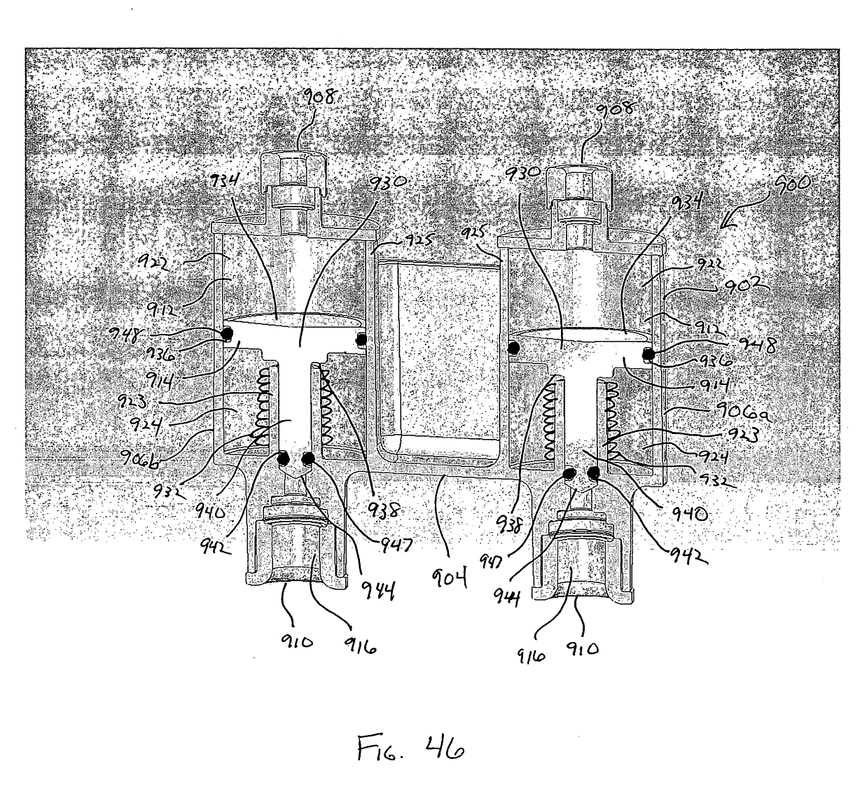

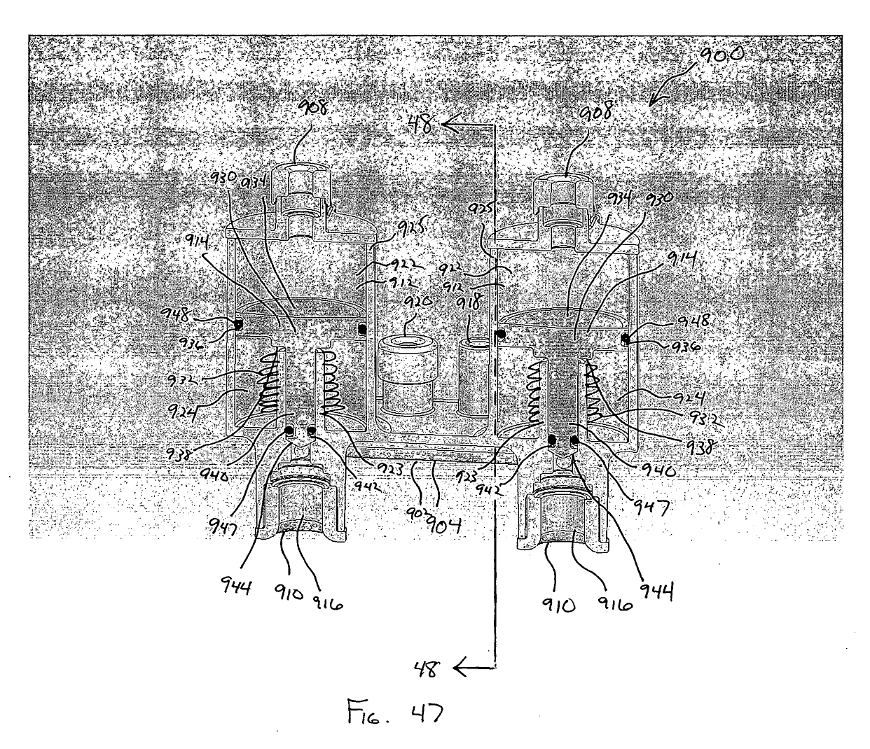

As illustrated in FIGS. 37-41, a representative fixed venturi injector assembly 860 can substantially resemble the appearance and function of adjustable venturi injector assembly 672 with the exception of not including the adjustable features associated with adjustable inlet assembly 724. Fixed venturi injector assembly 860 can comprise a fixed venturi body 862 having an injector inlet portion 864, an injector outlet portion 866, an additive portion 868 and a mix portion 870. Injector outlet portion 866 can substantially resemble injector outlet portion 680 while additive portion 868 can substantially resemble additive portion 682 as previously described.

Injector inlet portion 864 generally comprises a tapered flow channel 872 being defined by a tip opening 873, a tubing flange 874, a sealing flange 876, an abutment flange 878 and a connection flange 880. Connection flange 880 can further comprise a circumferential groove 882. Inlet tubing 736 is fluidly interconnected to tapered flow channel 872 using an inlet connector 884 comprising a sealing face 886, an abutment face 888, a connecting face 890 and a connector bore 892. Connecting face 890 can further comprise a circumferential weld director 894. Injector inlet portion 864 can further comprise a seal 896 and a retainer ring 898.

Injector inlet portion 864 can be assembled by placing inlet connector 884, seal 896 and retainer ring 898 over inlet tubing 736. Inlet tubing 736 is inserted into tapered flow channel 872 until inlet tubing 736 abuts tubing flange 874. While maintaining contact between the inlet tubing 736 and tubing flange 874, inlet connector 884 is advanced such that sealing face 886 causes compression of seal 896 to make a fluid tight seal between inlet tubing 736, sealing flange 876 and sealing face 886. When inlet connector 884 is fully advanced, suitable joining techniques such as, for example, spin welding or ultrasonic welding techniques can be used to permanently attach connection flange 880 and connecting face 890. For example, circumferential weld director 894 can be melted so as to flow into circumferential groove 882 whereupon hardening, the inlet connector 884 is permanently joined to injector inlet portion 864. After permanent connection of inlet connector 884 to injector inlet portion 864, retainer ring 898 prevents inlet tubing 736 from being withdrawn from connector bore 892.

In operation, fixed venturi injector assembly 860 can be used within a fluid treatment system such as, for example, fluid treatment system 616 in a similar manner as adjustable venturi injector assembly 672 with the exception that the position of tip opening 873 is fixed relative to the mix portion 870 such that the amount of vacuum drawn on additive portion 868 is constant resulting in a constant amount of additive such as, for example, rinse aid is dispensed into the fluid stream.

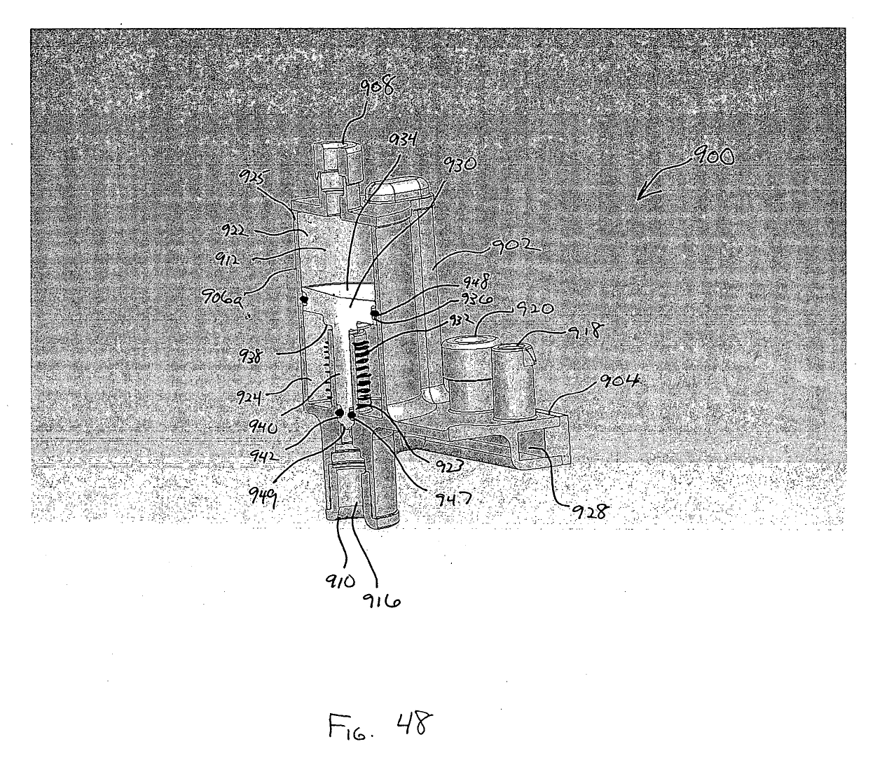

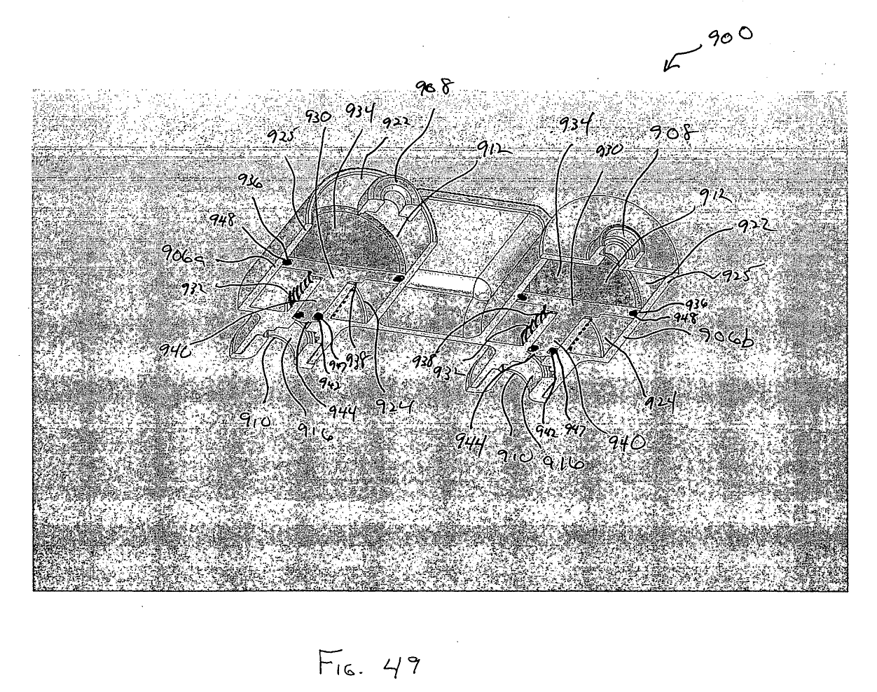

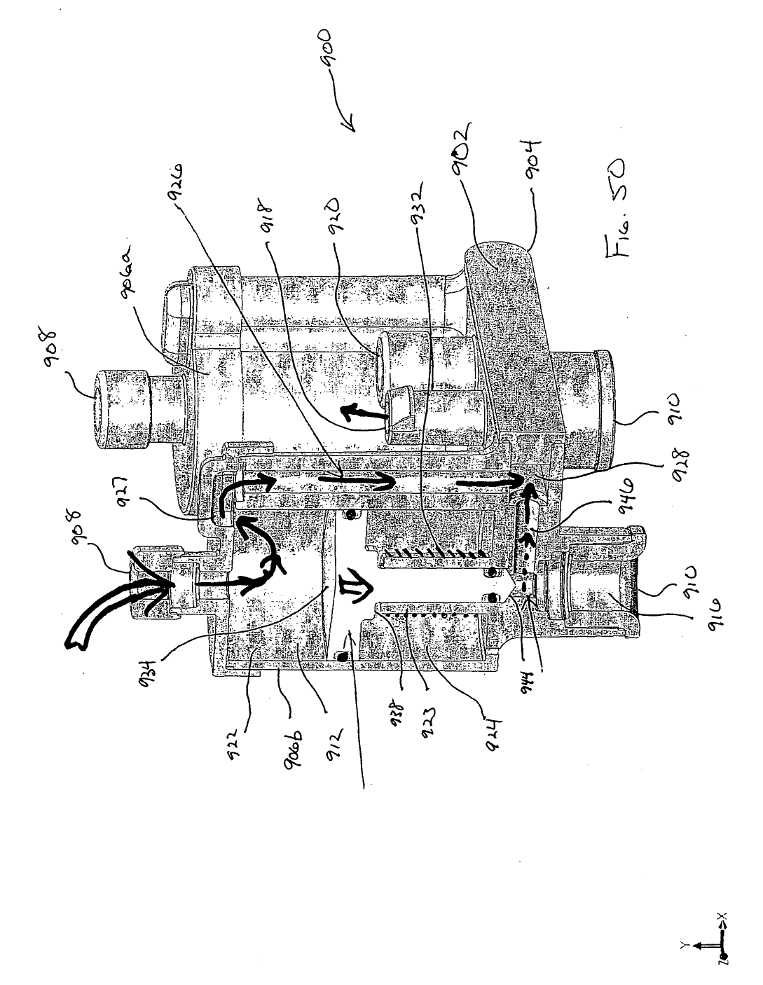

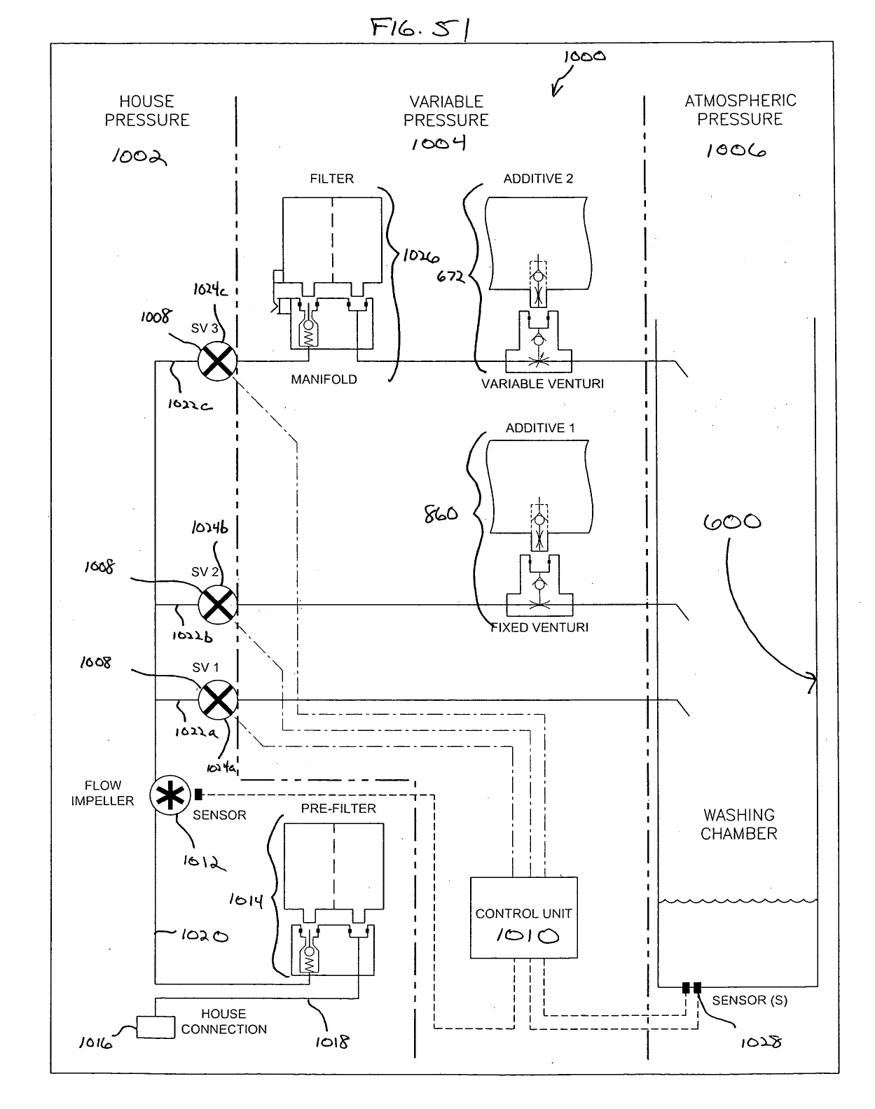

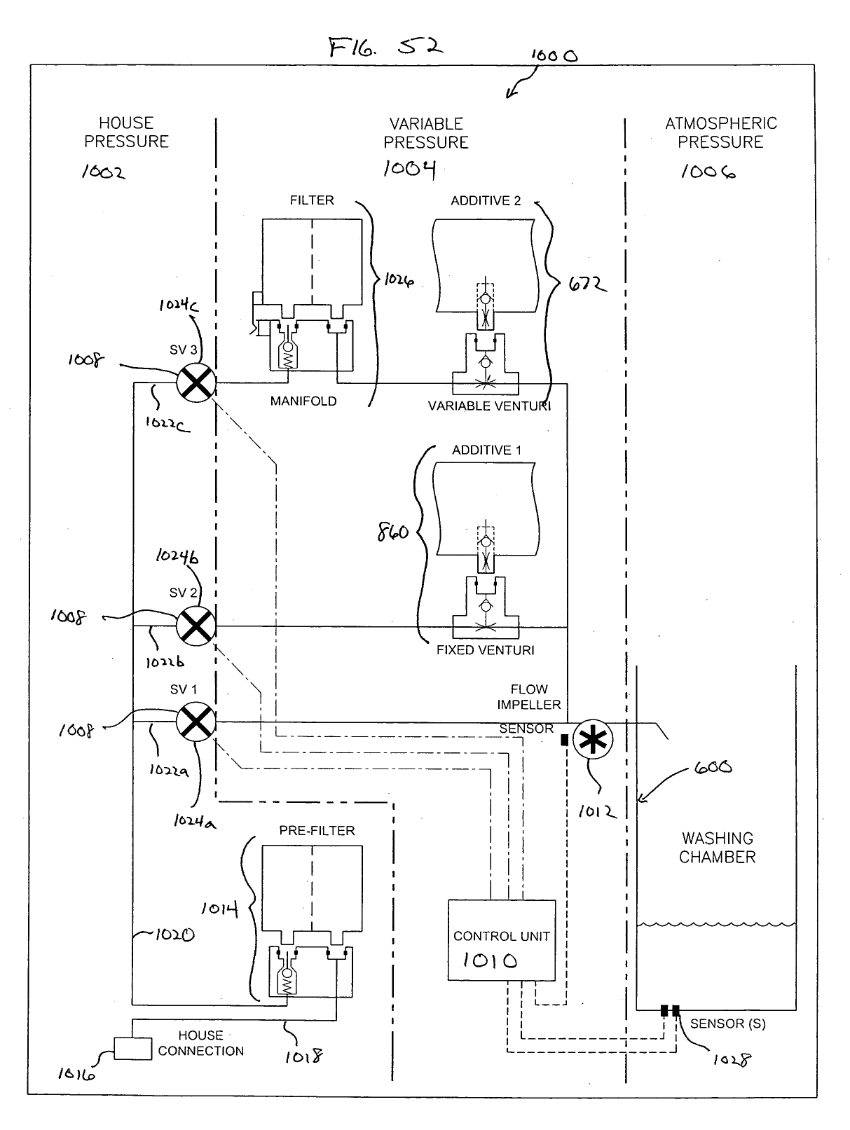

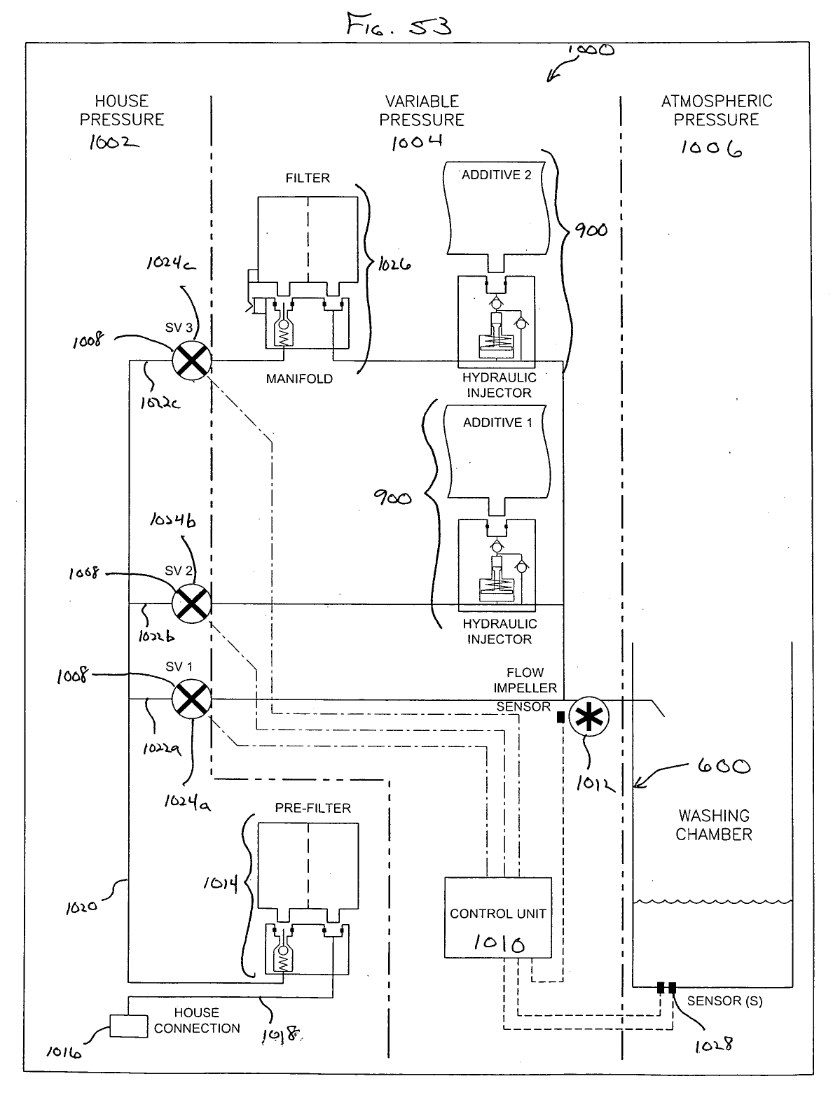

A representative hydraulic injector assembly 900 for use with fluid treatment systems such as, for example, fluid treatment system 616 is illustrated in FIGS. 42-49. As illustrated, hydraulic injector assembly comprise a dual-injector arrangement 902 though construction and operation of hydraulic injectors can be similarly performed for single chamber or three or more chamber arrangements. Dual-injector arrangement 902 generally comprises a body assembly 904 defining a first injector 906a and a second injector 906b. Each injector generally comprises a fluid flow inlet 908, an additive inlet 910, an injector interior 912, a piston assembly 914 and an additive injection portion 916. Body assembly 904 further comprises a fluid flow outlet 918 and in some representative embodiments can further comprise a flow bypass inlet 920. Injector interior 912 generally comprises a wet portion 922, a hollow projection 923, a dry portion 924 and an injector wall 925. A continuous fluid circuit 926 is generally defined between fluid flow inlet 908 and fluid flow outlet 918. Continuous fluid flow circuit 926 is generally defined by an inlet channel 927, wet portion 922 and an outlet channel 928. In some representative embodiments, hydraulic injector assembly 900 is designed and fabricated to accommodate fluid inlet pressures from about 20 psig to about 150 psig.

Piston assembly 914 generally comprises a piston body 930 and a piston spring 932. Piston body 930 comprises a major surface 934, a major surface seal groove 936, an abutment portion 938, a piston projection 940, a projection seal groove 942 and an injection surface 944. Piston projection 940 is configured for slidable placement within hollow projection 923 while piston spring 932 is configured for slidable placement over the hollow projection 923.

Additive inlet 910 can substantially resemble additive inlet portion 682 as previously described with respect to the adjustable venturi injector assembly 672 such that additive inlet 910 can selectively interface with additive assembly 810 as previously described. Additive inlet 910 is fluidly interconnected to fluid flow outlet 910 with an additive flow channel 946.

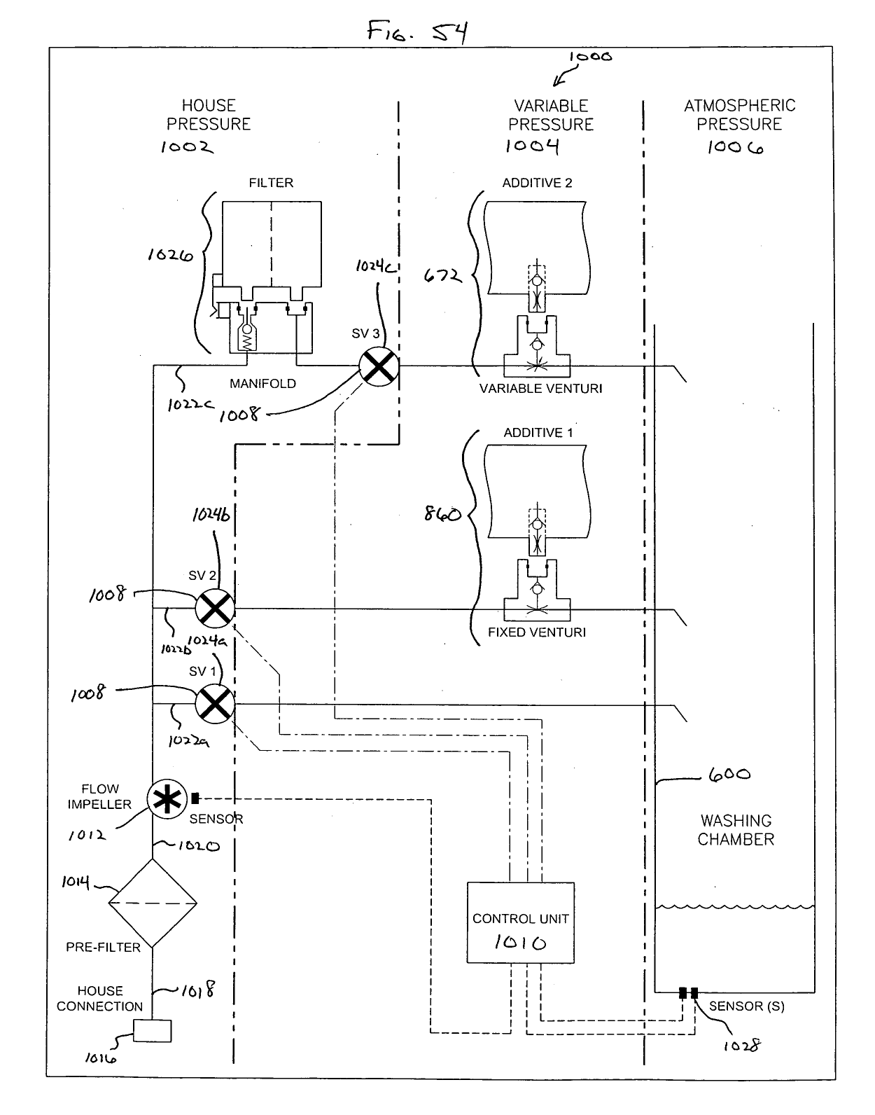

Use and operation of hydraulic injector assembly 900 will be described with reference to addition of a rinse additive in fluid treatment system 616. It is to be understood by one of skill in the art that hydraulic injector assembly 900 can be similarly employed in the addition of wash soap, detergent and the like. Furthermore, use and operation of hydraulic injector assembly 900 will be as depicted in FIG. 50 and described only with respect to second injector 906b though it will be understood by one of skill in the art that similar use and operation of first injector 906a as well as any additional injectors that can comprise hydraulic injector assembly 900.

Prior to commencing operation of dishwasher 600, piston spring 932 resides in a relaxed, expanded state such that injection surface 944 is directed to a point furthest away from the additive inlet 910. At this time, rinse aid from the additive assembly 810 fills the open volume within both the open portion of the hollow projection 923 and the additive flow channel 946. An additive seal 947 mounted within the projection seal groove 942 prevents leaking of the rinse aid into the wet portion 922.

Upon initiation of a rinse cycle, fluid flow is directed into the fluid flow inlet 908. The incoming fluid enters the wet portion 922 wherein a fluid seal 948 mounted within major surface seal groove 936 prevents the fluid from leaking into both the dry portion 924 and the additive flow channel 946. The pressure of the incoming fluid acts upon major surface 934 causing compression of piston spring 932 until the abutment portion 938 contacts the hollow projection 923. As piston spring 932 is compressed, injection surface 944 is directed toward additive inlet 910 causing the rinse aid within the additive flow channel 946 to be directed into outlet channel 928. Within outlet channel 928, the fluid and the rinse aid are mixed and directed through the fluid flow outlet 918 for delivery into interior compartment 612.

The amount of rinse aid administered by hydraulic injector assembly 900 can be measured and adjusted in a variety of ways. In some representative embodiments, the dimensions of the hollow projection 923, the piston projection 940 and/or the additive flow channel 946 can be selected such that the initial volume of stored rinse aid is increased or decreased. In some representative embodiments, first injector 906a can comprise a volume of stored rinse aid of about 1 mL, and up to about 5 mL. Alternatively, dishwasher 600 can cycle the introduction of fluid flow into fluid flow inlet 908, for example cycling with four to five second delays, in order to get multiple volumes of rinse aid to be dispensed during a selected washing/rinsing cycle.

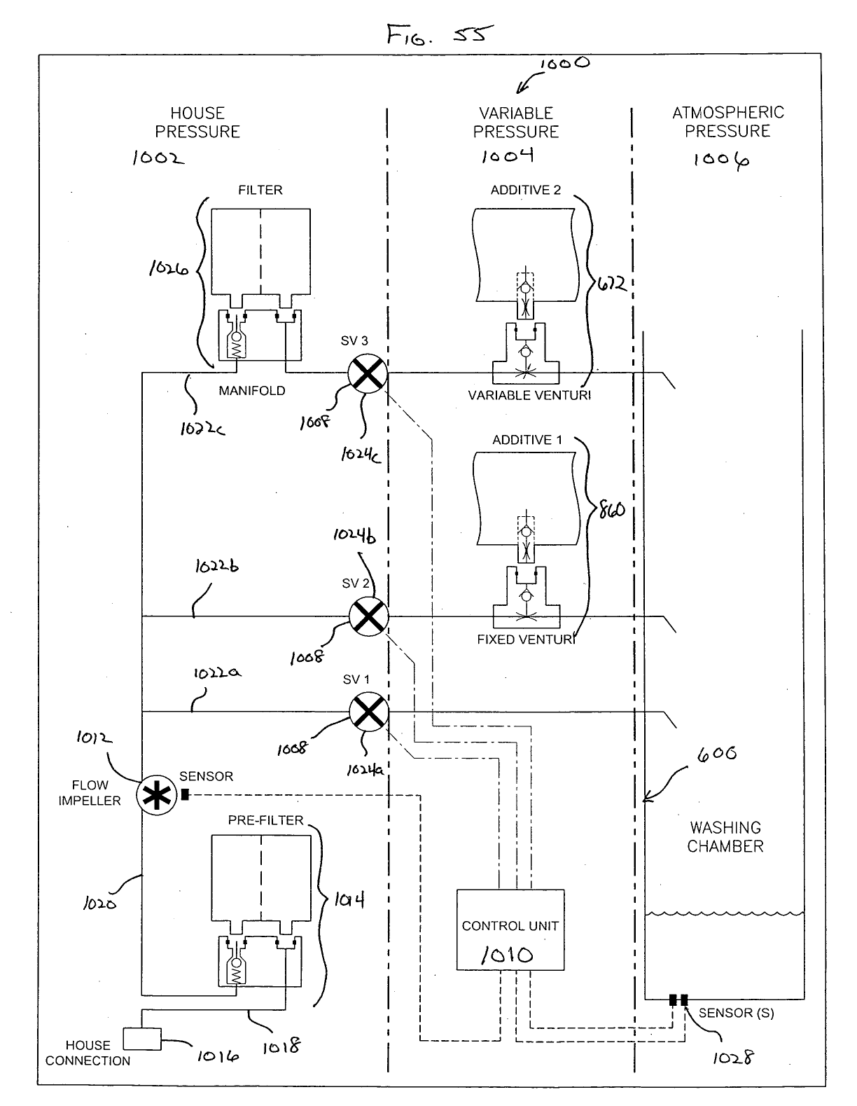

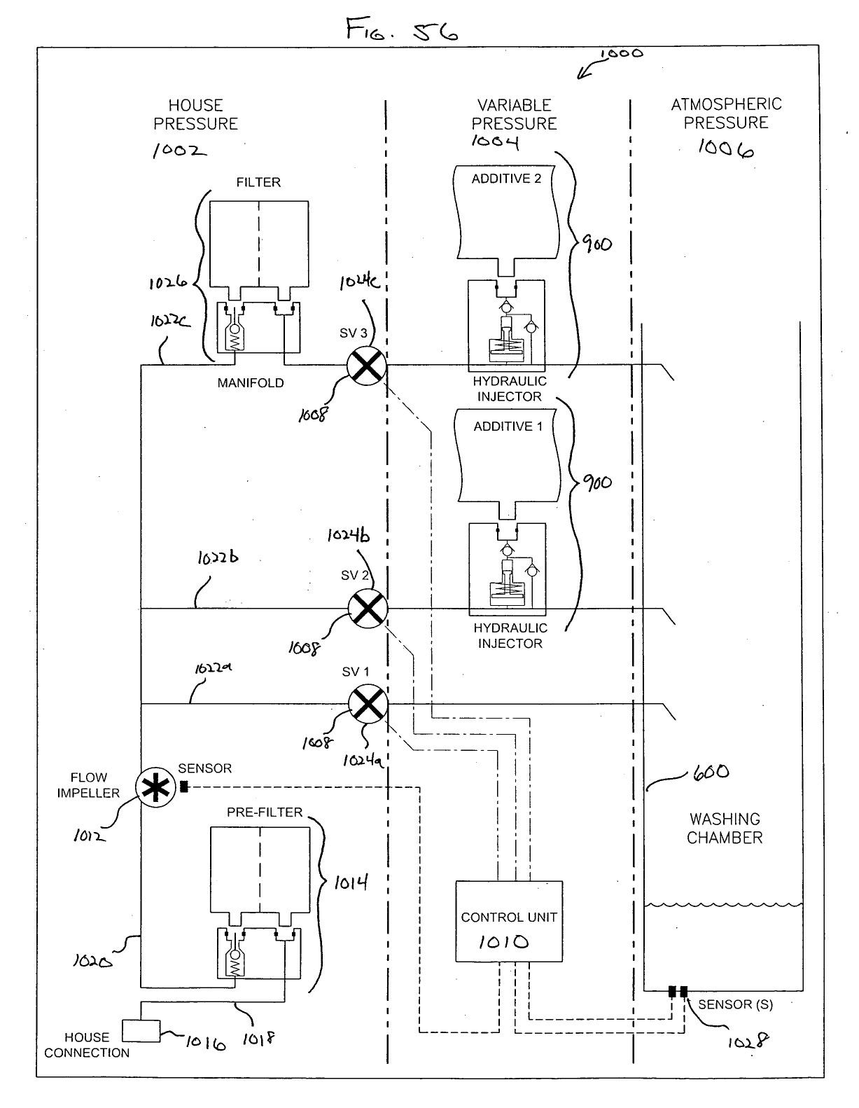

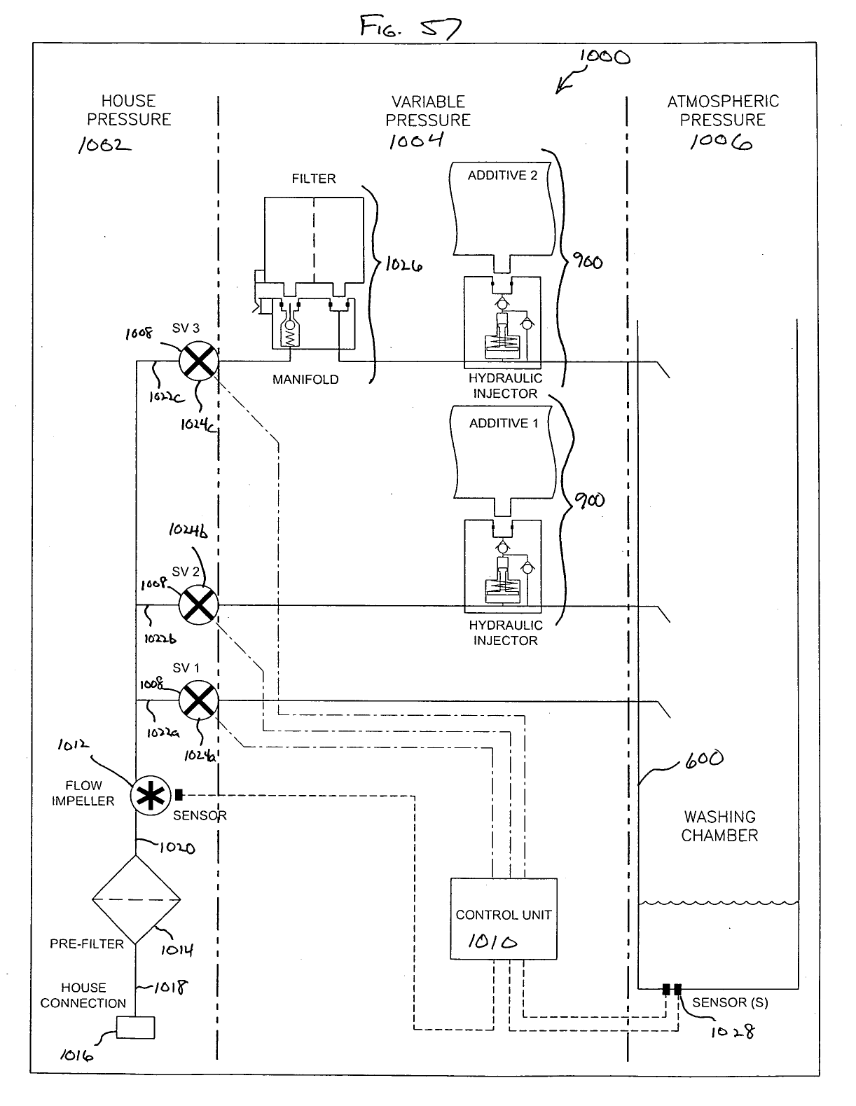

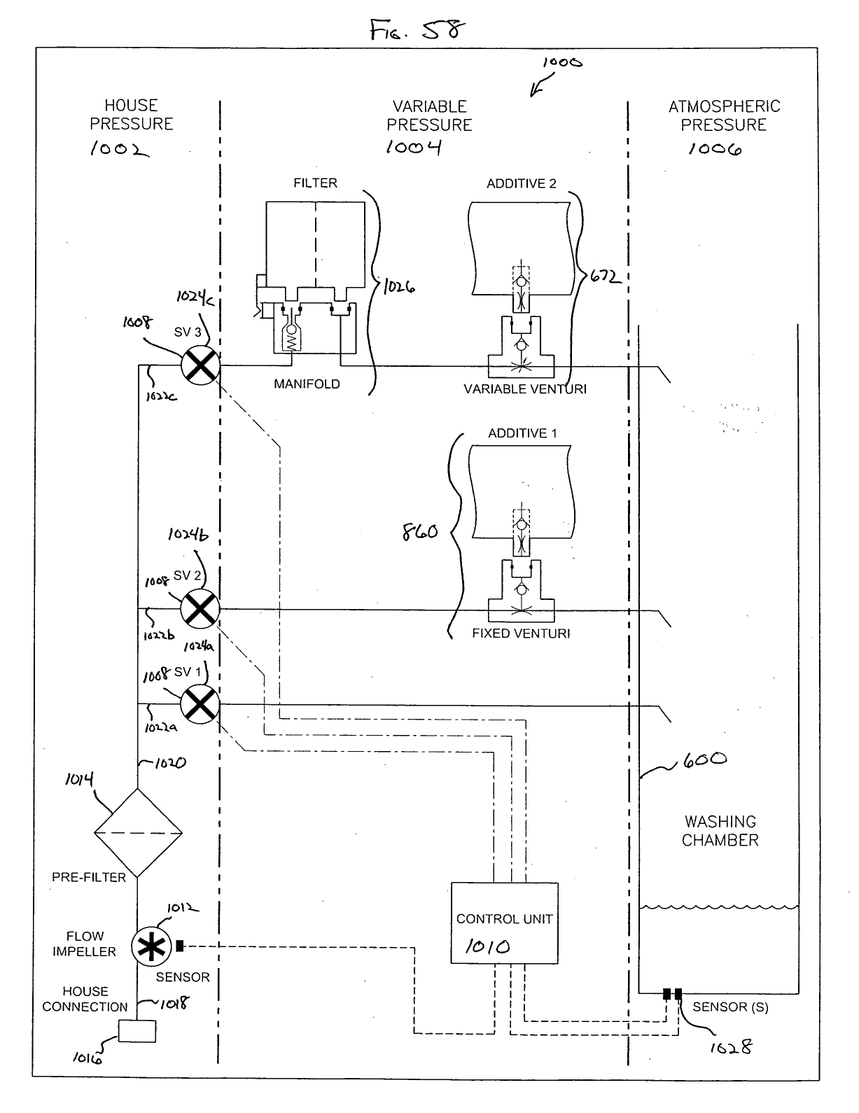

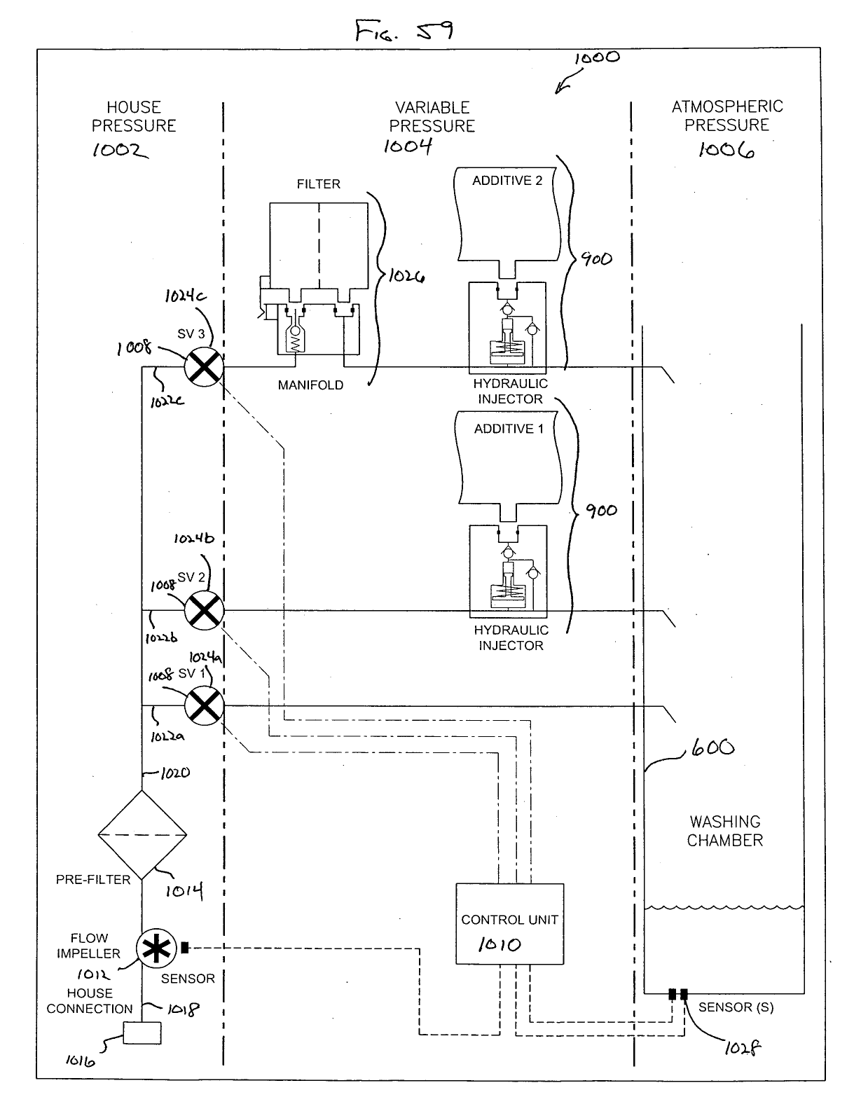

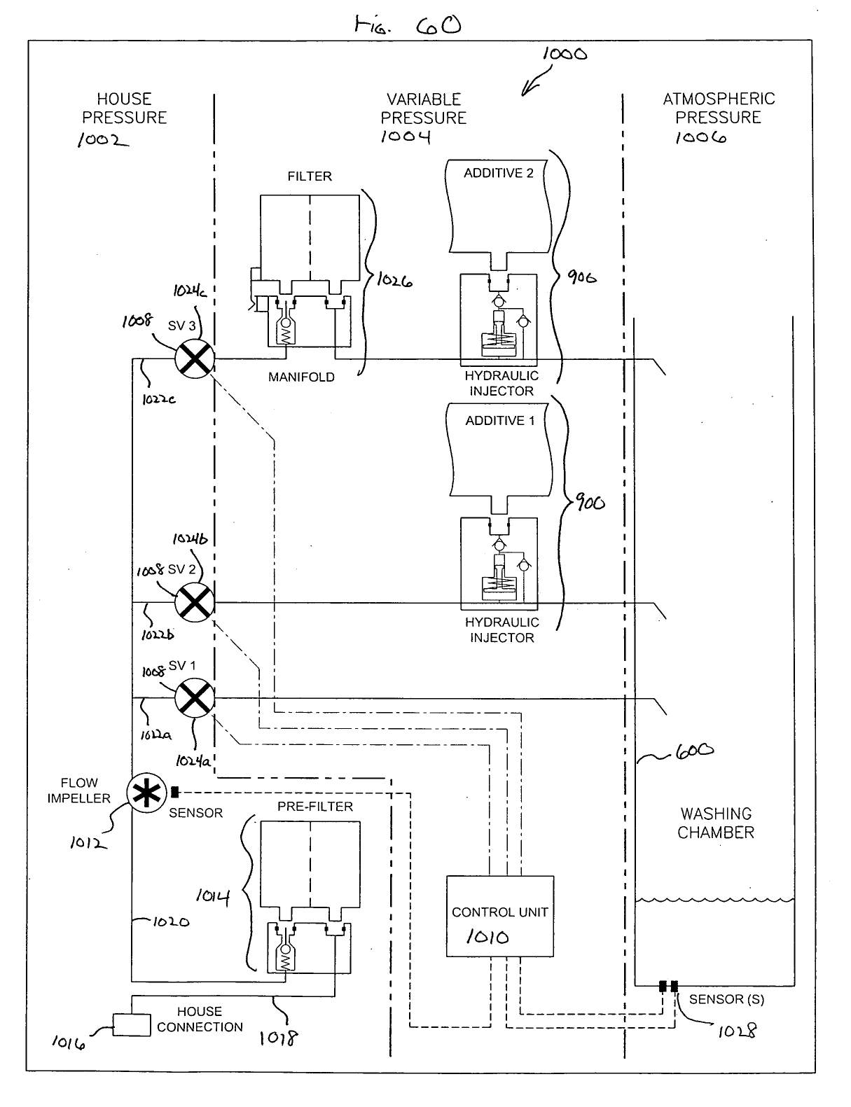

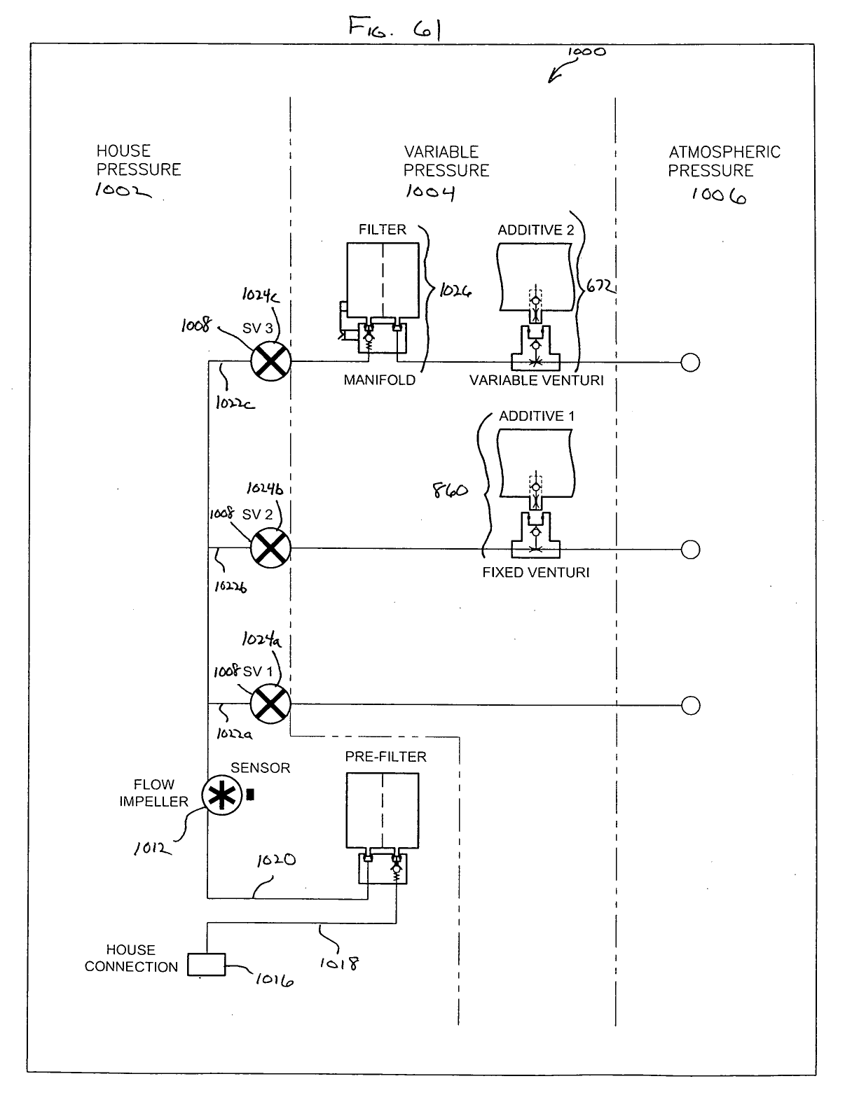

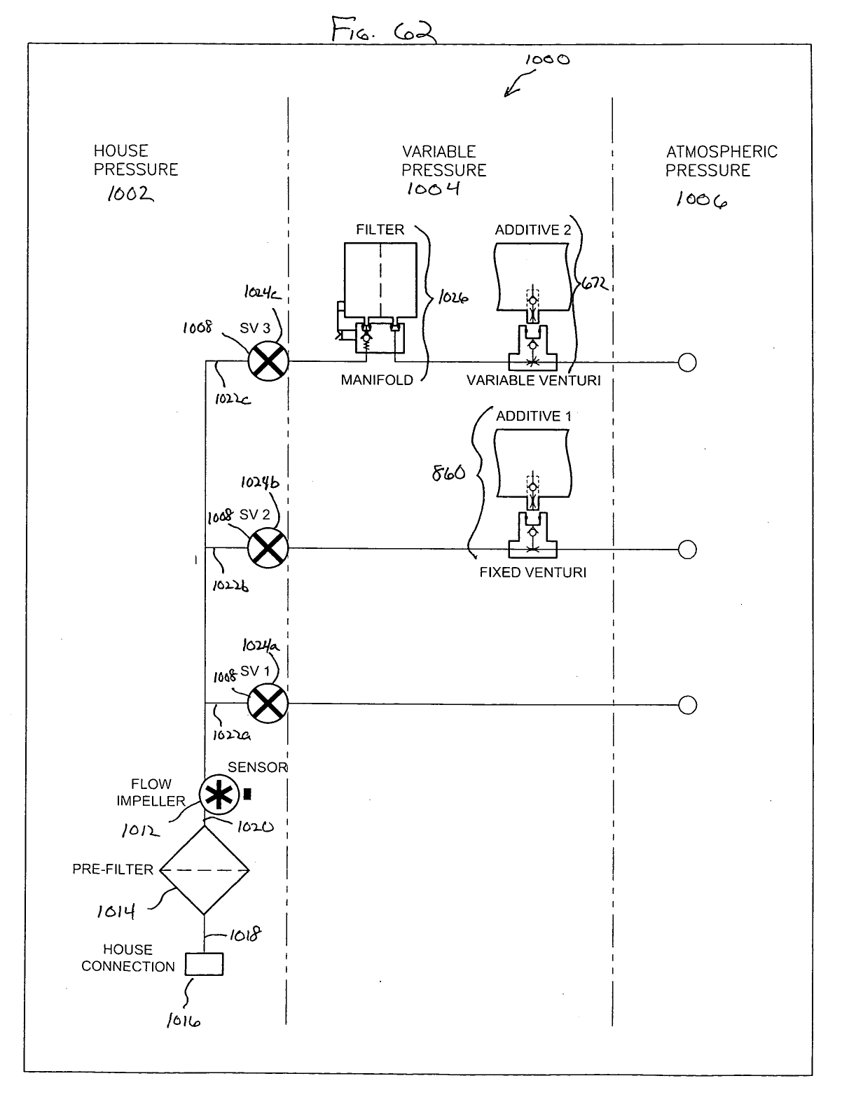

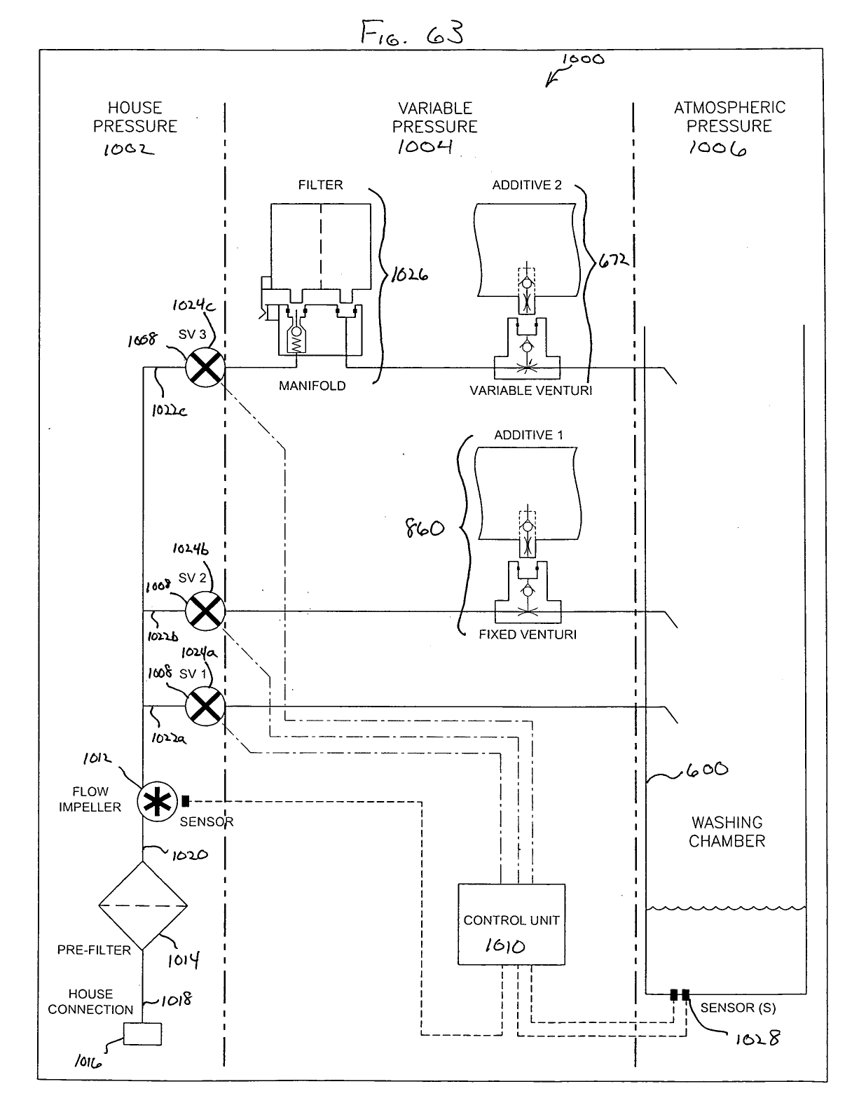

As illustrated schematically in FIGS. 51-63, representative embodiments of a fluid treatment system 1000 can comprise similar components arranged in a variety of configurations based upon factors such as water quality, desired wash and rinse qualities and the level of complexity of dishwasher 600. Generally, each of the embodiments of fluid treatment system 1000 can be broken down into three distinct pressure regions: a house pressure region 1002, a variable pressure regions 1004 and an atmospheric pressure region 1006.

House pressure region 1002 generally refers to areas of fluid treatment system 1000 directly upstream of one or more inlet valves 1008. Inlet valves 1008 can comprise suitable actuatable valves such as, for example, solenoid valves. The components of fluid treatment system 1000 within the house pressure regions 1002 must be designed and fabricated to accommodate standard house pressures such as, for example, between about 20 psig to about 120 psig. In addition to possessing one or more inlet valves 1008, house pressure regions 1002 can in some representative embodiments include a flow restriction member such as, for example, an orifice for reducing or “throttling” an inlet supply pressure prior to the fluid entering the variable pressure region 1004. The inlet valves 1008 and/or orifice can be utilized to reduce the inlet supply pressure to below about 120 psig.

Variable pressure region 1004 generally refers to areas of fluid treatment system 1000 located directly downstream of one or more inlet valves 1008. Variable pressure regions 1004 are protected from exposure to house pressure through the selective operation of inlet valves 1008 and/or an orifice. For instance, component within the variable pressure region 1004 can be exposed to atmospheric pressure when dishwasher 600 is not in operation and can be exposed to some pressure between house pressure and atmospheric pressure when dishwasher 600 is in operation.

Atmospheric pressure region 1006 generally refers to areas of fluid treatment system 1000 fluidly interacting with interior compartment 612 of dishwasher 600. Atmospheric pressure regions 1006 generally comprises various fluid lines for use in delivering fluids to dishwasher 600 such as, for example, tap water, filtered water, detergents, soaps, rinse additives and combinations thereof. Atmospheric pressure region 1006 operates at essentially atmospheric pressure when delivering fluids to dishwasher 600.

By providing distinct pressure regions for fluid treatment system 1000, manufacturing costs can be reduced as portions of the fluid treatment system 1000 are protected from operational exposure to high pressure operating conditions, generally considered fluid pressures of 120 psig or greater in the present application. As variable pressure region 1004 and atmospheric pressure region 1006 are protected from high pressure conditions, the various components which make up variable pressure region 1004 and atmospheric pressure region 1006 can be manufactured to accommodate lower pressures than house pressure region 1002. For example, the components fluidly located within variable pressure 1004 and atmospheric pressure region 1006 can be manufactured with reduced wall thicknesses, thus reducing raw material costs.

Fluid treatment system 1000 can comprise a variety of physical configurations including unitary manifold based systems wherein at least some of the components are integrally contained within a common structure. Alternatively, fluid treatment system 1000 can comprise a variety of individual components that are fluidly interconnected with appropriate fluid connections such as, for example, tubing and tubing connectors. In addition, fluid treatment system 1000 can comprise a control element 1010 such as, for example, a Programmable Logic Controller (PLC), or a microprocessor or relay based controller for selectively opening and closing one or more inlet valves 1008 so as to perform desired washing cycles. While each of FIGS. 51-63 have a control element 1010, a person of ordinary skill in the art will recognize the particular programming or other design features will depend on the other features specific to that embodiment. In addition, fluid treatment system 1000 can comprise additional components such as, for example, fluid flow sensors 1012, such as rotometers, turbines, ultrasonic and/or paddlewheel sensors, as well as a prefilter assembly 1014.

Operation of fluid treatment system 1000 is described with specific reference to FIG. 51 but one of appropriate skill in the art will appreciate the alternative modes of operation further illustrated in FIGS. 52-63. The fluid treatment system 1000 of FIG. 51 is fluidly connected to a fluid source at house connection 1016. House connection 1016 can comprise a suitable connection such as, for example, permanent or disassemblable tubing fittings. A fluid inlet stream 1018 is directed through prefilter assembly 1014 wherein the flow of a filtered inlet stream 1020 is measured by fluid flow sensor 1012. Fluid flow sensor 1012 can electrically communicate flow information to control element 1010. Filtered inlet stream 1020 can then be divided into three distinct supply streams 1022a, 1022b and 1022c wherein flow through each stream is controlled by an inlet valve 1024a, 1024b, 1024c with each inlet valve being operably connected to the control element 1010. Control element 1010 can comprise a user interface such as, for example, push buttons, a dial or a touch screen such that a user can select a desired wash cycle for cleaning dishes within dishwasher 600. Based on the desired wash cycle, control element 1010 selectively opens inlet valves 1024a, 1024b and 1024c in the desired sequence and for the desired amounts of time associated with the selected wash cycle.

A representative wash cycle can incorporate a variety of stages including, for example, a filling stage, a washing stage and a rinse stage. During the filling stage, control element 1010 can open inlet valve 1024a causing water to flow from house connection 1016, into fluid inlet stream 1018, through prefilter assembly 1014 and fluid flow sensor 1012. The water is directed through supply stream 1022a and into the dishwasher 600. Control element 1010 can close inlet valve 1024a based upon a level switch within the dishwasher 600 or based upon the measured amount of flow through fluid flow sensor 1012.

During the washing stage, control element 1010 can open inlet valve 1024b causing water to flow from house connection 1016, into fluid inlet stream 1018, through prefilter assembly 1014 and fluid flow sensor 1012. The water is directed through supply stream 1022b and through the fixed venturi injector assembly 860 such that a wash additive can be added to the water prior to entering the dishwasher 600. Control element 1010 can close inlet valve 1024b based upon a level switch within the dishwasher 600 or based upon the measured amount of flow through fluid flow sensor 1012. In addition, control element 1010 can provide an indication such as, for example, a visual or audible indicator to alert a user that the fixed venturi injector assembly 860 is running low on wash additive based upon the amount of flow measured by fluid flow sensor 1012 that has been directed through supply stream 1022b.

During the rinse stage, control element 1010 can open inlet valve 1024c causing water to flow from house connection 1016, into fluid inlet stream 1018, through prefilter assembly 1014 and fluid flow sensor 1012. The water is directed through supply stream 1022c and through a rinse filter 1026 followed by adjustable venturi injector assembly 672 such that a rinse additive can be added to the water prior to entering the dishwasher 600. Rinse filter 1026 can provide polishing of the water after prefilter assembly 1014, for example, removing hardness, iron and/or other dissolved solids to provide improved rinse performance. Control element 1010 can close inlet valve 1024c based upon a level switch 1028 within the dishwasher 600 or based upon the measured amount of flow through fluid flow sensor 1012. In addition, control element 1010 can provide an indication such as, for example, a visual or audible indicator to provide a user that the adjustable venturi injector assembly 672 is running low on rinse additive based upon the amount of flow measured by fluid flow sensor 1012 that has been directed through supply stream 1022c.

Although various embodiments of the disclosure have been discussed and illustrated, it should be understood that a variety of changes, modifications and substitutions can be incorporated without departing from either the spirit or scope of the present disclosure.

What is claimed:

1. A wash appliance having an integral fluid treatment system comprising:
a wash appliance housing; and
a fluid treatment system in the wash appliance housing, the fluid treatment system comprising:
one or more filtration stages for filtering water supplied from a fluid source inlet;
one or more additive dispensers in fluid communication with the one or more filtration stages and capable of adding one or more additives to the fluid; and
a controller for coordinating the flow of the fluid through one or more filtration stages and/or one or more additive dispensers.

2. The wash appliance of claim 1 wherein the wash appliance is a dishwasher or a clothes washer.

3. The wash appliance of claim 1 wherein the one or more filtration stages comprises a prefilter and a final rinse filter.

4. The wash appliance of claim 1 wherein the one or more filtration stages comprises replaceable treatment cartridges.

5. The wash appliance of claim 1 wherein the one or more additive dispensers comprise an additive introduction valve, additive introduction injector, or additive introduction pump.

6. The wash appliance of claim 1 further comprising a flow sensor in fluid communication with the one or more filtration stages and one or more additive dispensers and operably connected to the controller.

7. The wash appliance of claim 1 wherein the one or more additive dispensers is two additive dispensers.

8. The wash appliance of claim 1 wherein the one or more filtration stages and the one or more additive dispensers are in the form of a unitary insertion structure.

9. The wash appliance of claim 5 wherein the one or more additive dispensers further comprise an additive reservoir connected to the additive introduction valve, additive introduction injector, or additive introduction pump.

10. The wash appliance of claim 1 wherein the one or more additive dispensers is an additive dispenser for dispensing soap or an additive dispenser for dispensing rinse additive into the fluid.

11. The wash appliance of claim 4 wherein the replaceable treatment cartridges comprise depth filtration media, surface filtration media, crossflow filtration media, ion exchange media, activated carbon media, and combinations thereof.

12. The wash appliance of claim 10 wherein the fluid treatment system further comprises a rinse valve in fluid communication with a filtration stage and operably connected to the controller and: 1) a wash valve in fluid communication with the filtration stage and a soap dispenser and operably connected to the controller; 2) a final rinse valve in fluid communication with filtration stage and a rinse additive dispenser and operably connected to the controller; or 3) a wash valve in fluid communication with the filtration stage and a soap dispenser and operably connected to the controller, and a final rinse valve in fluid communication with the filtration stage and a rinse additive dispenser and operably connected to the controller, wherein when the wash and/or final rinse valves are opened by the controller, the valves direct fluid through the soap and/or rinse additive dispenser and soap and/or rinse additive is introduced into the fluid.

13. The wash appliance of claim 1 wherein the one or more filtration stages comprises one or more replaceable filtration cartridges, and the one or more filtration cartridges are each capable of individual replacement.

14. The wash appliance of claim 9 wherein the additive introduction injector comprises a fixed venturi injector, an adjustable venturi injector, or a hydraulic injector.

15. The wash appliance of claim 9 wherein the additive reservoirs are capable of individual replacement and/or replenishment of their capacity.

16. A fluid treatment system for use in a washing appliance comprising:
one or more filtration stages for filtering water supplied from a fluid source inlet;
an actuatable rinse valve in fluid communication with the one or more filtration stages for directing fluid into a washbasin of the washing appliance and operably connected to a controller;
one or more additive dispensers in fluid communication with the one or more filtration stages and capable of adding one or more additives to the fluid before the treated fluid is directed to the washbasin; and
at least one actuatable additive valve in fluid communication with the one or more filtration stages, the additive valve capable of directing fluid to the one or more additive dispensers, the at least one additive valve being operably connected to the controller.

17. The fluid treatment system of claim 16 wherein the at least one additive valve is operably electrically connected to the controller.

18. The fluid treatment system of claim 16 wherein the one or more filtration stages comprise depth filtration media, surface filtration media, adsorptive media, crossflow filtration media, ion exchange media, activated carbon media, and combinations thereof.

19. The fluid treatment system of claim, 16 wherein the one or more additive dispensers comprise an additive introduction valve, additive introduction injector, or additive introduction pump.

20. The fluid treatment system of claim 19 wherein the one or more additive dispensers further comprise an additive reservoir connected to the additive introduction valve, additive introduction injector, or additive introduction pump.

21. The fluid treatment system of claim 20 wherein the additive introduction injector comprises a fixed venturi injector, an adjustable venturi injector, or a hydraulic injector.

22. The fluid treatment system of claim 20 wherein the one or more additive reservoirs are capable of individual replacement and/or replenishment of their capacity.

23. The fluid treatment system of claim 16 wherein the one or more filtration stages is a prefilter having a replaceable cartridge, wherein the actuatable rinse valve is a solenoid valve, wherein the at least one additive valve is a solenoid valve, and wherein the additive dispenser comprises a hydraulic injector assembly and an additive reservoir fluidly connected to an additive inlet of the hydraulic injector assembly.

24. An integral fluid treatment system for use in a washing appliance comprising:
a fluid treatment system assembly in fluid communication with a fluid distribution manifold assembly, and a controller operably connected to the fluid distribution manifold, the fluid treatment system assembly comprising:
a prefilter assembly comprising a prefilter manifold and a prefilter cartridge replaceably attached to the prefilter manifold; and
a wash additive assembly comprising a wash additive introduction member having a fluid inlet, a wash additive inlet, and a fluid outlet for dispensing fluid containing wash additive, and a wash additive reservoir connected to the wash additive inlet of the wash additive introduction member; or
a rinse additive assembly comprising a rinse additive introduction member having a fluid inlet, an additive inlet, and a fluid outlet for dispensing fluid containing rinse additive, and a rinse additive reservoir connected to the rinse additive inlet of the rinse additive member; or
both the wash additive assembly and the rinse additive assembly;
the distribution manifold assembly comprising a distribution manifold body having an internal distribution flow channel that operably fluidly interconnects a manifold fluid inlet and manifold fluid outlets, a fluid inlet valve, and fluid outlet valves operably, sealably mounted to the distribution manifold body to control fluid flow through the manifold fluid inlet and corresponding manifold fluid outlets, the manifold fluid outlets being fluidly connected to the fluid treatment system.

25. The integral fluid treatment system of claim 24 wherein the fluid treatment assembly is adapted to be placed within a door of the washing appliance.

26. The integral fluid treatment system of claim 24 wherein the distribution manifold assembly is adapted to be placed near a door of the washing appliance.

27. The integral fluid treatment system of claim 24 wherein each additive introduction member comprises a hydraulic injector.

28. The integral fluid treatment system of claim 24 wherein each additive reservoir is replaceable or replenishable.

29. The integral fluid treatment system of claim 24 wherein each additive introduction member comprises a venturi injector.

30. The integral fluid treatment system of claim 24 wherein the fluid inlet and outlet valves of the manifold assembly are solenoid valves electrically operably connected to the controller.

31. An adjustable venturi injector assembly and additive assembly for injecting an additive into a fluid comprising:
an adjustable venturi body having a fluid mix portion operably, fluidly interconnecting a fluid inlet flow portion, a fluid outlet flow portion, and an additive inlet flow portion having an additive inlet, wherein the fluid inlet portion comprises an inlet internal surface defining a cavity and an adjustable inlet connector body having a tapered flow channel, wherein the adjustable inlet connector body is movable concentrically within the fluid inlet portion cavity; and
an additive assembly comprising an additive reservoir fluidly connected to the additive inlet of the adjustable venturi body.

32. The adjustable venturi injector assembly and additive assembly of claim 31 wherein the additive inlet is fluidly connected to an additive connection assembly and the additive connection assembly includes a check valve within the additive connection assembly, the check valve being capable of opening when subjected to venturi induced vacuum.

33. The adjustable venturi injector assembly and additive assembly of claim 31 wherein the additive inlet is fluidly connected to an additive connection assembly and wherein the additive reservoir comprises a flexible bag having a handling end and a dispensing end and a dispenser assembly on the dispensing end, the dispenser assembly comprising a dispenser body adapted for insertion into the additive connection assembly.

34. The adjustable venturi injector assembly and additive assembly of claim 31 wherein the adjustable inlet connecter body has a circumferential thread engaged with inlet internal surface thread.

35. The adjustable venturi injector assembly and additive assembly of claim 34 wherein the adjustable inlet connector body is concentrically moveable within the fluid inlet portion cavity by means of engaging the threads through rotational motion.

36. The adjustable venturi injector assembly and additive assembly of claim 32 wherein the check valve within the additive connection assembly comprises a ball positioned proximate a spring.

37. The adjustable venturi injector assembly and additive assembly of claim 33 wherein the dispenser body contains a check valve capable of preventing reverse flow into the bag.

38. A fixed venturi injector assembly and additive assembly for injecting an additive into a fluid comprising:
a fixed venturi body having a fluid mix portion fluidly interconnecting a fluid inlet flow portion, a fluid outlet flow portion, and an additive inlet flow portion having an additive inlet fluidly connected to an additive connection assembly; and
an additive assembly comprising an additive reservoir fluidly connected to the additive inlet of the fixed venturi body.

39. The fixed venturi injector assembly and additive assembly of claim 38 wherein the additive connection assembly includes a check valve within the additive connection assembly, the check valve being capable of opening when subjected to venturi induced vacuum.

40. The fixed venturi injector assembly and additive assembly of claim 38 wherein the additive reservoir comprises a flexible bag having a handling end and a dispensing end and a dispenser assembly on the dispensing end, the dispenser assembly comprising a dispenser body adapted for insertion into the additive connection assembly.

41. The fixed venturi injector assembly and additive assembly of claim 40 wherein the dispenser body contains a check valve capable of preventing reverse flow into the bag.

42. A hydraulic injector assembly for injecting an additive into a fluid comprising:
a body assembly comprising an injector having an interior and a fluid flow outlet,
the injector comprising a fluid flow inlet fluidly connected to the injector interior, a biased piston assembly inside the injector interior, the piston assembly comprising a piston body having a major surface end and a distal injection surface end connected by a piston projection, the piston body capable of being moved in a direction opposite the fluid flow inlet when fluid contacts the major surface end of the piston, the distal surface of the piston in fluid communication with an additive inlet, the additive inlet in fluid communication with the fluid outlet via an additive flow channel.

43. The hydraulic injector assembly of claim 42 wherein the body assembly further comprises a fluid flow bypass inlet.

44. The hydraulic injector assembly of claim 42 wherein the piston projection is configured for slidable placement within the injector interior and within a hollow projection located within the injector interior.

45. The hydraulic injector assembly of claim 42 wherein the body assembly further comprises a second injector the second injector comprising a second fluid flow inlet fluidly connected to a second injector interior, a second biased piston assembly inside the second injector interior, the second piston assembly comprising a second piston body having a major surface end and a distal injection surface end connected by a piston projection, the second piston body capable of being moved in a direction opposite the fluid flow inlet when fluid contacts the major surface end of the piston, the distal surface of the piston in fluid communication with a second additive inlet, the second additive inlet in fluid communication with the fluid outlet via a second additive flow channel.
